(19) United States
(12) Patent Application Publication
(10) Pub. No.: US 2024/0372755 A1
(43) Pub. Date: Nov. 7, 2024

(54) COMMUNICATION DEVICE AND METHOD FOR PERFORMING COMMUNICATION SIGNAL PROCESSING

(71) Applicant: Intel Corporation, Santa Clara, CA (US)

(72) Inventors: Yang-Seok CHOI, Portland, OR (US); Jan SCHRECK, Scotts Valley, CA (US); Shilpa TALWAR, Cupertino, CA (US); Tariq QURESHI, Hillsboro, OR (US); Sagar DHAKAL, Los Altos, CA (US); Thomas TETZLAFF, Hillsboro, OR (US); Thushara HEWAVITHANA, Tempe, AZ (US)

(21) Appl. No.: 18/556,373

(22) PCT Filed: Dec. 22, 2021
(86) PCT No.: PCT/US2021/064764

§ 371 Date: Oct. 20, 2023

(51) Int. Cl. H04L 25/02; H04L 5/00

(52) U.S. Cl. CPC H04L 25/0254; H04L 5/0007

(57) ABSTRACT

According to various examples, communication device is described comprising a receiver configured to receive a signal from another communication device via a radio channel and a processor configured to estimate a power delay profile of the radio channel by maximum likelihood estimation of the power delay profile from the received signal and perform receive signal processing in accordance with the estimated power delay profile.

### TECHNICAL FIELD

Exemplary implementations described herein generally relate to communication devices and methods for performing communication signal processing.

### BACKGROUND

The reception of communication signals in modern radio communication systems may be a complicated task, mainly for the reason that the available spectrum should be used as efficiently as possible. The reception in particular includes determining channel characteristics (like a power delay profiles etc.) and from these, communication (processing) control information (such as filter weights, beamforming weights etc.). Efficient and accurate approaches for making performing these kinds of determinations and calculations are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an exemplary communication arrangement according to an embodiment.

FIG. 2 illustrates the training of a neural network.

FIG. 3 illustrates splitting a neural network into multiple sub-networks.

FIG. 4 illustrates adding an extra output based on domain knowledge to a neural network.

FIG. 5 illustrates adding an additional input variable based on domain knowledge to a neural network.

FIG. 6 illustrates adding pre-processing and post-processing to a neural network.

FIG. 7 illustrates performance results.

FIG. 8 illustrates performance results.

FIG. 9 illustrates performance results.

FIG. 10 illustrates the training of a neural network for maximum likelihood estimation of a PDP (power delay profile).

FIG. 11 illustrates performance results.

FIG. 12 illustrates performance results when using the PDP estimation approach described above in terms of normalized mean square error for denoising received pilot symbols in a WiFi set-up (and denoising per OFDM symbol).

FIG. 13 depicts an overview of the uplink and downlink of a communication system.

FIG. 14 illustrates a PDP quantization according to an embodiment.

FIG. 15 shows a neural network according to an embodiment.

FIG. 16 shows diagrams showing the performance of a neural network-based filter approach.

FIG. 17 illustrates a sounding reference signal (SRS) processing flow.

FIG. 18 illustrates a neural network-based SRS processing according to an embodiment.

FIG. 19 illustrates results of a frequency-domain channel estimation for a single channel realization.

FIG. 20 shows a comparison of the performance of a neural network-based SRS processing and time domain processing.

FIG. 21 shows performance results.

FIG. 22 shows a comparison of the performance of a neural network-based SRS processing and time domain processing.

FIG. 23 shows a communication device according to various embodiments.

FIG. 24 shows a flow diagram 2400 illustrating a method for determining a channel characteristic.

FIG. 25 shows a flow diagram illustrating a method for performing receive signal processing.

FIG. 26 shows a flow diagram 2600 illustrating a method for performing receive signal processing.

FIG. 27 shows a flow diagram illustrating a method for filtering a signal received via wireless communication.

FIG. 28 shows a flow diagram illustrating a method for performing radio communication signal processing.

### DESCRIPTION OF EXEMPLARY IMPLEMENTATIONS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

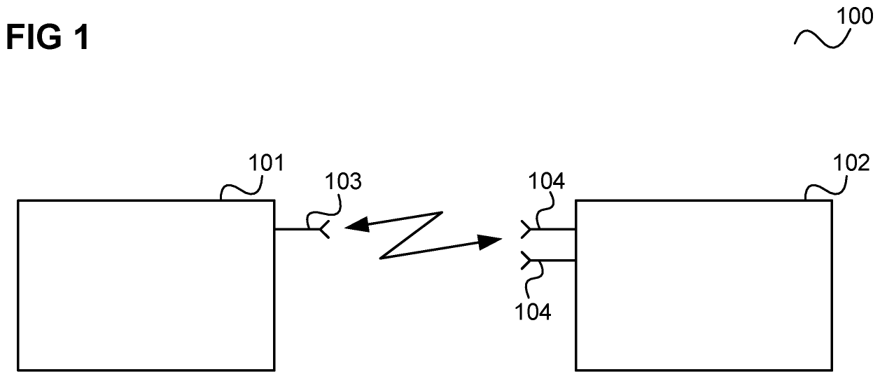

FIG. 1 shows an exemplary communication arrangement 100 according to an embodiment.

The communication arrangement 100 includes a first communication device 101 and a second communication device 102. For example, the communication arrangement 100 is part of a mobile communication system and the first communication device 101 is a mobile terminal (e.g. a smartphone) and the second communication device 102 is a base station. Accordingly, transmission of data from the first communication device 101 to the second communication device 102 is also referred to as uplink transmission and the transmission of data from the second communication device 102 to the first communication device is also referred to as downlink communication.

The first communication device (e.g. a mobile terminal, UE (user equipment)) 101 includes at least one antenna 103 and the second communication device (e.g. a base station) includes at least one antenna 104. In this example, it is assumed that the base station 102 includes multiple antennas to allow, for example, beamforming. Using the antennas 103, 104 the communication devices 101, 102 exchange signals. The communication devices 101, 102 generate these signals from data to be transmitted in accordance with a radio transmission technology such as OFDM (Orthogonal Frequency Division Multiplexing). Thus, signals representing data to be exchanged are transmitted between the communication devices 101, 102 via a (wireless) communication channel 105.

The first communication device 101 and the second communication device 102 may for example communicate via the communication channel 105 in accordance with 3GPP (Third Generation Partnership Project) 4G or 5G communication, i.e. for example LTE (Long Term Evolution), LTE-A (LTE Advanced), 5G NR (New Radio) etc. but also according to other radio technologies, e.g. local area network communication technologies like WiFi according to any IEEE 802.11 version.

The communication channel 105 has various characteristics which the communication devices 101, 102 need to know to perform efficient communication with each other, like for example the channel matrix or channel vector (e.g. channel frequency response per sub-carrier and/or antenna), channel quality metrics (e.g. to decide whether to perform a handover), the power delay profile (PDP) in a multipath environment etc. A communication device 101, 102 may determine these characteristics of the communication channel 105 from signals it receives via the communication channel 105 from the other communication device 101, 102.

However, it may be hard to find an accurate model-based solution for determining the communication channel characteristics. Further, many modes and parameters may need to be optimized and it may be computationally impossible to implement the optimum solution. Therefore, approaches based on artificial intelligence or machine-learning may be used, in particular neural networks. These approaches use data driven learning that can infer solutions to problems which are hard to model and may provide computationally realizable implementations.

A neural network may be trained in a supervised manner using a training data set including training data elements, wherein each training data element includes input data for the neural network and target output data (also referred to as target output data).

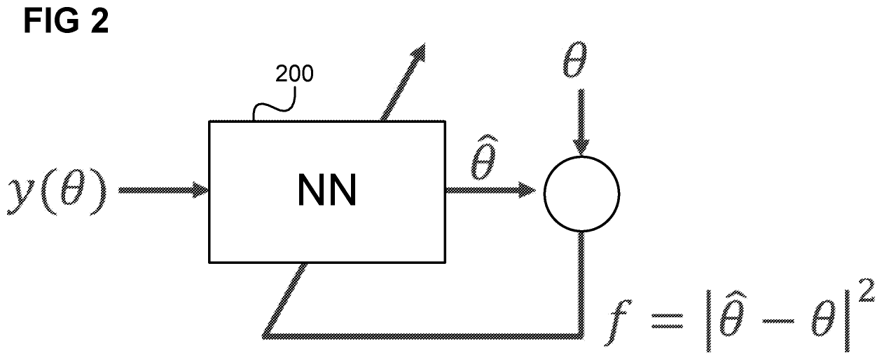

FIG. 2 illustrates the training of a neural network 200.

For training the neural network 200, a respective training process (running on a computer which also implements the neural network) supplies input data y(θ) of a training data element to the neural network 200. The neural network 200 processes the input data y(θ) and generates an output \hat{θ}. For inference in deployment, the input data is for example a received (e.g. pilot) signal and the output is a channel estimation. The training process relates the output \hat{θ} with a target output (ground truth) θ of the training data element. The result is a loss ƒ. In this example, ƒ is simply represented as a squared difference between the generated output and the target output ƒ=|\hat{θ}−θ|² but more complicated losses (and loss functions) may be used. The training process adapts parameters of the neural network (typically the weights) to reduce the loss (i.e. such that the neural network 200 produces an output that is closer to target output in the sense that the loss is reduced). Typically, batches of training data elements are used. This means that the training process aggregates the loss over multiple training data elements and adapts the neural network to reduce the aggregated loss.

By the training, the neural network 200 learns a model from the training data. Typically, the neural network 200 then works well for the training data set, i.e. outputs good results for input data which occurred in the training data set. However, when being provided with other (random) input data or data having different statistics that the input data in the training data, it may not work so well. This means that the neural network 200 is not robust (or does not generalize well). Further, supervised learning as described above requires ground truth data that is not easily available. Also, overfitting to the training data may cause performance loss as well.

According to various embodiments, domain knowledge regarding the model that the neural network is supposed to learn is used to address the above issues. This may for example include splitting the neural network in multiple parts, adding additional input and output to the neural network and add pre- and post-processing in order to inject domain knowledge into the neural network architecture. These techniques may allow unsupervised learning, avoid overfitting and provide better robustness. They may for example be applied to location estimation, beamforming and channel estimation. The mentioned techniques for injecting domain knowledge in a neural network architecture are described in more detail in the following.

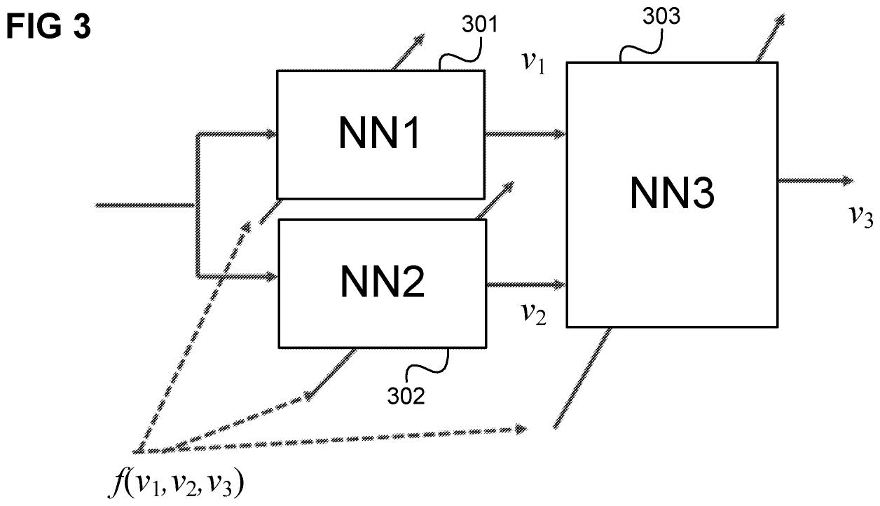

FIG. 3 illustrates splitting a neural network (and, correspondingly, the problem to be solved by the neural network) into multiple parts, in this example three sub-networks 301, 302, 303.

As illustrated, this may be done serially and/or parallelly taking into account domain knowledge. By smartly splitting a problem according to domain knowledge, the load of each neural network 301, 302, 303 becomes less and a cost function can be constructed which avoids supervised learning by developing a cost function ƒ using the meaning or property of each output, here (v₁, v₂, v₃), of the neural networks 301, 302, 303. The cost function bonds all local neural network by domain knowledge.

Further, by splitting a problem, there may be multiples pairs of input and target output data for training for each pair of input and target output data (of the original neural network). This can help to avoid overfitting and impose domain knowledge indirectly.

Splitting a problem as much as possible leads to that each sub-problem (into which the problem is split) becomes a simple calculation like an addition or multiplication etc. In these small problems, the neural network performance depends less on the meaning of input and output variables. Simply, the neural network mimics the calculation of the respective function, leading to less overfitting.

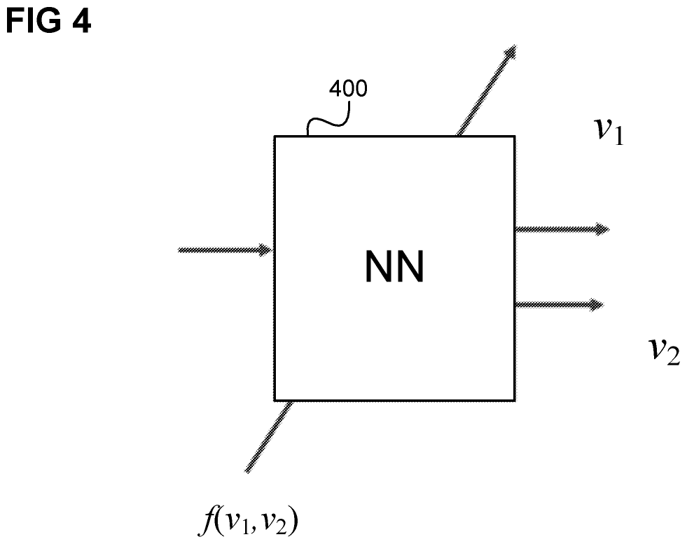

FIG. 4 illustrates adding an extra output (v₂) based on domain knowledge to a neural network 400. Although the additional output variable is not used for further processing (i.e. by downstream components), it can help inserting domain knowledge and properties of the problem to be solved into the neural network architecture. The neural network 400 may be trained by combining two cost functions ƒ(v₁), ƒ(v₂) or a joint cost function ƒ(v₁, v₂).

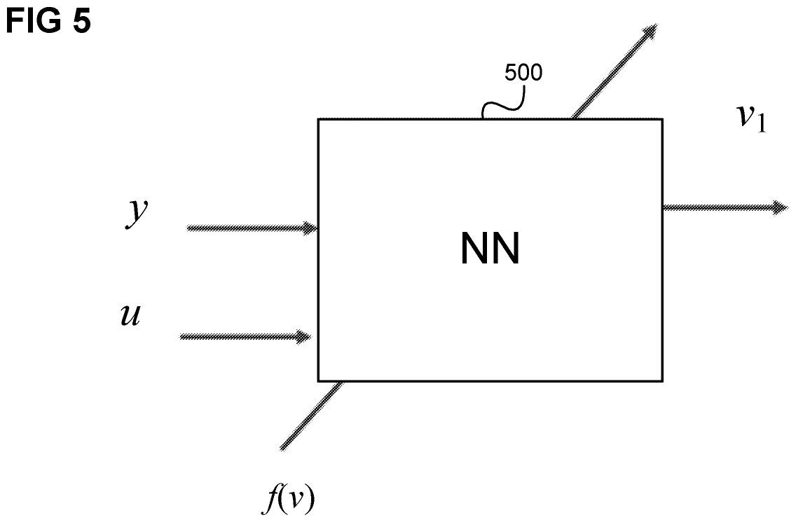

FIG. 5 illustrates adding an additional input variable (u) based on domain knowledge to a neural network 500. The additional input variable may be chosen using any domain knowledge or domain information or variables.

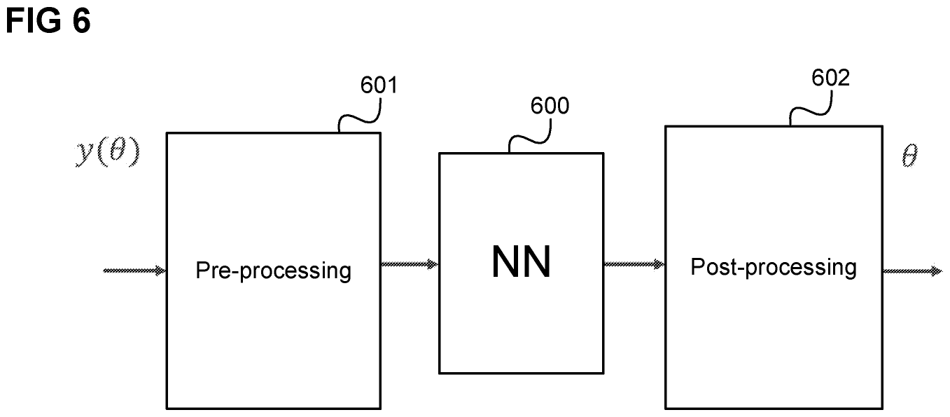

FIG. 6 illustrates adding pre-processing 601 and post-processing 602 to a neural network 603.

The pre-processing 601 pre-processes (e.g. transforms) input data for the neural network 600 and the post-processing 602 pre-processes (e.g. transforms) output data provided by the neural network 603.

The pre-processing 601 and post-processing 602 can help the neural network 603 to converge fast and reduce the neural network complexity. Transforming observation and output data in order to make the problem more neural network friendly makes it easier for the neural network 603 to extract feature as feature can be deeply buried in observation. As an example, pre- and post-processing can be FFT or IFFT.

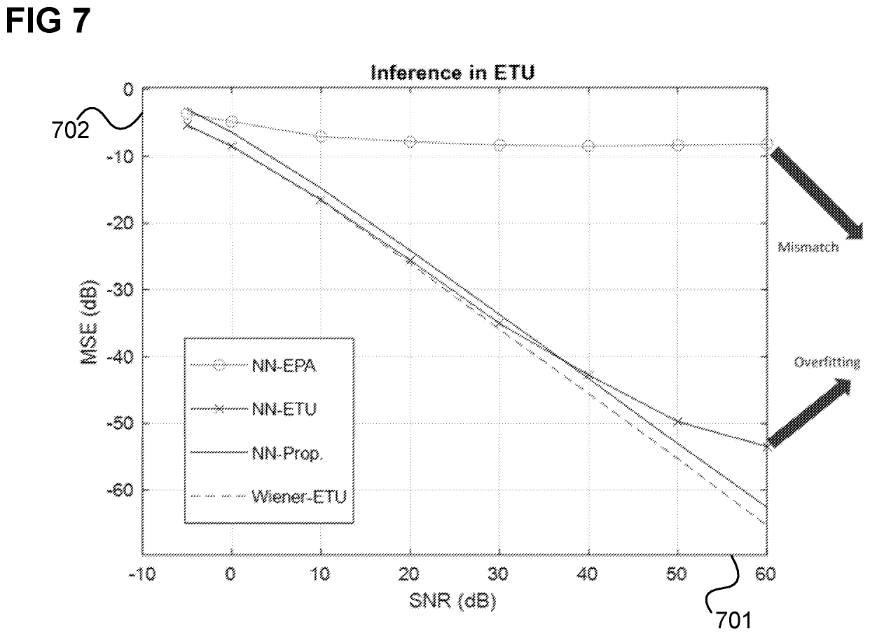

FIG. 7 illustrates performance results when using domain knowledge in a neural network architecture according to the techniques described above applied to a channel estimation problem.

Mean squared error of the channel estimation for ETU (Extended Typical Urban model) channel model is indicated along the vertical axis 701 (i.e. the channel estimation error under ETU channel model, i.e. with validation data generated according to ETU channel model) and signal-to-noise-ratio is indicated along the horizontal axis 702. The performance of a neural network based on domain knowledge (“NN-prop.”) is compared to a neural network trained for ETU (“NN-ETU”) channel model, i.e. with training data generated according to the ETU channel model, a neural network trained for EPA (Extended Pedestrian A) channel model (“NN-EPA”), i.e. with training data generated according to the ETU channel model, and an ideal Wiener filter for ETU channel model (“Wiener-ETU”).

The results shown are results of inference (or validation). For this, random realizations of channels are generated which are different from the channels seen during training. NN-EPA and NN-ETU are generic neural networks trained under the EPA and the ETU channel model, respectively. As can be seen, NN-ETU exhibits great match to the theoretical limit (i.e. ideal Wiener filter under ETU) at low SNR. However, at high SNR there is an error floor which comes from overfitting, i.e. the generic neural network shows poor performance under new random realizations of an ETU channel at high SNR.

When NN-EPA is tested under the ETU channel model, the performance is much worse as NN-EPA is trained and optimized under EPA channel model.

In contrast, NN-Prop. shows no error floor and its performance is close to the ideal bound even if it is not trained under ETU channel model.

Since the wireless channel 105 is unpredictable and time varying and the number of wireless channels with different characteristics, a robust solution is desirable which allows determining channel characteristics for any possible wireless channel. The approaches described above allow providing such a robust solution without the need for online training (i.e. with using off-line training only).

In the following, examples of applying the techniques described above with regard to the introduction of domain knowledge into a neural network architecture are described with regard to determining characteristics of a communication channel (and further information derived from these characteristics).

One example relates to the determination of the power delay profile (PDP) for a wireless multi-path communication channel 105. For this, first, a method of estimating the power delay profile using one OFDM symbol which is not based on a neural network is described. This method may be used for generating training data for a neural network-based approach as will be described further below. The PDP can be seen as one of the most fundamental characteristics of a wireless multi-path communication channel. For example, knowledge of the PDP may play a critical role for performing at least some or all of the most critical physical layer tasks such as time of arrival estimation, channel estimation, channel compression and others.

As an alternative to the PDP determination, a Fixed Wiener filter uses a uniform PDP by assuming channel delay spread to be equal to the entire cyclic prefix duration. It conservatively estimates the correlation across pilot sub-carriers. However, this severely limits the amount of achievable denoising gain or achievable compression.

According to various embodiments, for estimating the PDP of the wireless (multi-path) communication channel 105, channel impulse response is modelled as a superposition of sinc functions sampled several times more than the critical sampling rate. When the communication device 101, 102 performing the PDP estimation receive an OFDM symbol, it estimates the power carried by each sinc function via minimizing a constrained log likelihood cost function associated with PDP. According to various embodiments, it does this by using an optimization technique that iterates according to the gradient of a cost function in tandem with low pass estimate of a Lagrangian multiplier.

This approach allows achieving, compared to a Fixed Wiener filter, up to 10 dB improvement in denoising gain (under the EPA channel model) consistently across varying channel statistics. Moreover, it can be achieved that even at high SNRs like 80 dB there is no error floor. Furthermore, low latency can be achieved as the approach uses just one OFDM symbol. For example, the approach can directly be applied to pilot patterns for LTE/LTE-A (Long Term Evolution, Long Term Evolution Advanced) as well as WiFi 802.11 versions.

According to various embodiments, a communication device 101, 102 determines the PDP from a signal received via the communication channel 105. The received signal (in frequency domain) is given by

$$y = H + n \qquad ( 1 )$$

in one OFDM symbol where H is a Qx1 channel vector represented in frequency domain, and n is a Qx1 Additive White Gaussian Noise (AWGN) noise vector with diagonal covariance 1/SNR I_{Q}, where SNR is signal to noise ratio. It is assumed that the frequency location of Q pilot sub-carriers and the estimate of noise variance are known at the receiver (i.e. the communication device 101, 102 which receives the signal).

It is assumed that the cyclic prefix duration is t_{CP} and the system sampling rate (used by the receiver) is ƒₛ. The receiver partitions the CP duration into N_{b} equally spaced bins (i.e. time intervals) by sampling at a rate x≥0 times the system sampling rate. It should be noted that the PDP is supposed to be within the cyclic prefix (CP). Therefore, the CP is divided into the bins. Therefore, there are N_{b}=xƒₛt_{CP} number of PDP segments, where each segment has length

$${T}_{seg} = \frac{{t}_{CP}}{{N}_{b}}$$

duration and segment boundaries are t₀, t₁, . . . , t_{N}_{_{b}}₋₁.

The PDP determination is based on modelling the channel impulse response h(τ) by infinitesimal increment in delay τ≥0 as

$$h ( τ ) = {\sum }_{b = 0}^{{N}_{b} - 1} {a}_{b} ( τ ) ( u ( τ - {t}_{b} ) - u ( τ - {t}_{b + 1} ) ) \qquad ( 2 )$$

where,

a_{b}(τ)˜CN(0,p_{b}/T_{seg}), p_{b} is the power received in bin b

$$E [ {a}_{b} ( {τ}_{k} ) {a}_{b}^{*} ( {τ}_{l} ) ] = 0 for {τ}_{k} \neq {τ}_{l} \\ E [ {a}_{{b}_{1}} ( τ ) {a}_{{b}_{2}}^{*} ( τ ) ] = 0 for {b}_{1} \neq {b}_{2}$$

and u(t) is a unit step function, which is equal to 1 for t≥0, and 0 otherwise.

Finally, for a given SNR, there is a constraint regarding the total received power given by

$${\sum }_{b = 0}^{{N}_{b} - 1} {p}_{b} = 1$$

Based on the impulse response model given in Eq. (2), the Q×Q channel covariance matrix for frequency domain channel H given in Eq. (1) is simply the sum of covariance matrices for each bin. More precisely,

$${R}_{H} = E [ \begin{matrix}H & {H}^{′}\end{matrix} ] = {\sum }_{b = 0}^{{N}_{b} - 1} {p}_{b} {R}_{b} \qquad ( 3 )$$

where,

R_{b}=Toeplitz(r_{b}) for b=0, . . . ,N_{b}−1

(i.e. the Toeplitz matrix whose first row is equal to r_{b}) and

$${r}_{b} = ( 1 , \frac{( {e}^{- i 2 π Δ {fT}_{seg}} - 1 ) {e}^{- i 2 π Δ f {t}_{b}}}{- i 2 π Δ {fT}_{seg}} , … \frac{( {e}^{- i 2 π ( Q - 1 ) Δ {fT}_{seg}} - 1 ) {e}^{- i 2 π ( Q - 1 ) Δ f {t}_{b}}}{- i 2 π ( Q - 1 ) Δ {fT}_{seg}} )$$

Δƒ is the pilot sub-carrier spacing, and i²=−1.

Based on the signal model given in Eq. (1) and channel impulse response model in Eq. (2), it can be seen that Y is zero-mean complex Gaussian vector whose covariance is given by:

$$\begin{matrix}K = E [ {YY}^{′} ] = {R}_{H} + {R}_{n} \\ = {\sum }_{b = 0}^{{N}_{b} - 1} {p}_{b} {R}_{b} + \frac{1}{SNR} {I}_{Q}\end{matrix}$$

Therefore, the joint probability density function (pdf) of real and imaginary components of Y is:

$${f}_{Y} ( Y ; p ) = \frac{1}{{π}^{Q} \vert K \vert} {e}^{- {Y}^{′} {K}^{- 1} Y} \qquad ( 4 )$$

Here, |K| is the determinant of matrix K. The pdf in Eq. (4) is explicitly parametrized by the PDP p=[p₀ . . . p_{N}_{_{b}}₋₁]. The maximum likelihood estimate of the PDP is given by

$${p}_{ML} = {max}_{p} {f}_{Y} ( Y ; p )$$

$$subject to$$

$${\sum }_{b = 0}^{{N}_{b} - 1} {p}_{b} = 1 and {p}_{b} \geq 0$$

Alternatively, the receiver can solve a dual problem given by

$${min}_{p} log \vert K \vert + {Y}^{′} {K}^{- 1} Y - λ ( {\sum }_{b = 0}^{{N}_{b} - 1} {p}_{b} - 1 ) + {\sum }_{b = 0}^{{N}_{b} - 1} {u}_{i} {p}_{b} \qquad ( 5 )$$

where λ≥0 is a scalar Lagrangian multiplier associated to equality constraint and u_{b} is a KKT (Karush-Kuhn-Tucker) multiplier associated with the b-th inequality constraint.

Differentiating Eq. (5) with respect to pᵢ and equating to zero gives

$$\frac{\partial }{\partial {p}_{b}} g ( p ) - λ + {u}_{b} = 0 \qquad ( 6 )$$

where g(p)=log|K|+Y′K⁻¹Y

Therefore,

$${∇}_{b} = \frac{\partial }{\partial {p}_{b}} g ( p ) = trace ( ( {I}_{Q} - {K}^{- 1} {YY}^{′} ) {K}^{- 1} {R}_{b} ) \qquad ( 7 )$$

The KKT complimentary condition for inequality constraint, i.e. uᵢpᵢ=0, means that for every pᵢ>0, uᵢ=0. Therefore, applying the KKT complimentary condition in Eq. (6), together with Eq. (7), gives for pᵢ>0:

$$trace ( ( {I}_{Q} - {K}^{- 1} {YY}^{′} ) {K}^{- 1} {R}_{b} - λ = 0 \qquad ( 8 )$$

A solution Eq. (8) for the tuple (p, λ) in closed form may not exist. Therefore, according to various embodiments, the reveiver numerically solves Eq. (8) for (p*, λ*), while satisfying Σ_{b=0}^{N}^{_{b}}⁻¹p*_{b}=1 as described below.

It should be noted that the PDP determination approach described can be extended to multiple OFDM symbols or to multiple denoising bands by simply adjusting Eq. (7) by

$$\frac{\partial }{\partial {p}_{b}} g ( p ) = trace ( ( {I}_{Q} - {K}^{- 1} \frac{{YY}^{′}}{N} ) {K}^{- 1} {R}_{b} \qquad ( 9 )$$

where Y is Q×N matrix representing Q number of pilot sub-carriers received across N number of OFDM symbols or N number of denoising bands. Further,

$$\frac{{YY}^{′}}{N}$$

is a sample covariance matrix based on N observations.

Numerical Optimization Algorithm for solving Eq. (8):
1. Initialize the tuple (p, λ) as λ=0, p_{b}=1/N_{b}, for b=0, . . . , N_{b}−1
2. a. Compute ∇_{b}=trace((I_{Q}−K⁻¹YY′)K⁻¹R_{b}
   b. Perform gradient descent (GD) with step size u≥0 as:

$${p}_{b} = max ( 0 , {p}_{b} - μ ( {∇}_{b} - λ ) ) for b = 0 , … , {N}_{b} - 1$$

c. Apply normalization as:

$${p}_{b} = \frac{{p}_{b}}{{\sum }_{b = 0}^{{N}_{b} - 1} {p}_{b}}$$

3. a. Form a set of all the bins with non-zero power S={b: p_{b}>0} for b=0, . . . , N_{b}−1
   b. Update λ using the low pass filter with forgetting factor ρ≥0

$$λ = ( 1 - ρ ) λ + ρ \frac{1}{\vert S \vert} {Σ}_{b ∈ S} {∇}_{b} ,$$

where |S| is the number of elements in set S.
4. Iterate in tandem between PDP update in Step 2 and Lagrange multiplier update in Step 3 until sufficient convergence is reached.

It should be noted that operation 3 in the algorithm exploits the KKT condition that at a global minimum the derivative of log likelihood with respect to every non-zero PDP bin must exactly equal to the optimal Lagrangian multiplier.

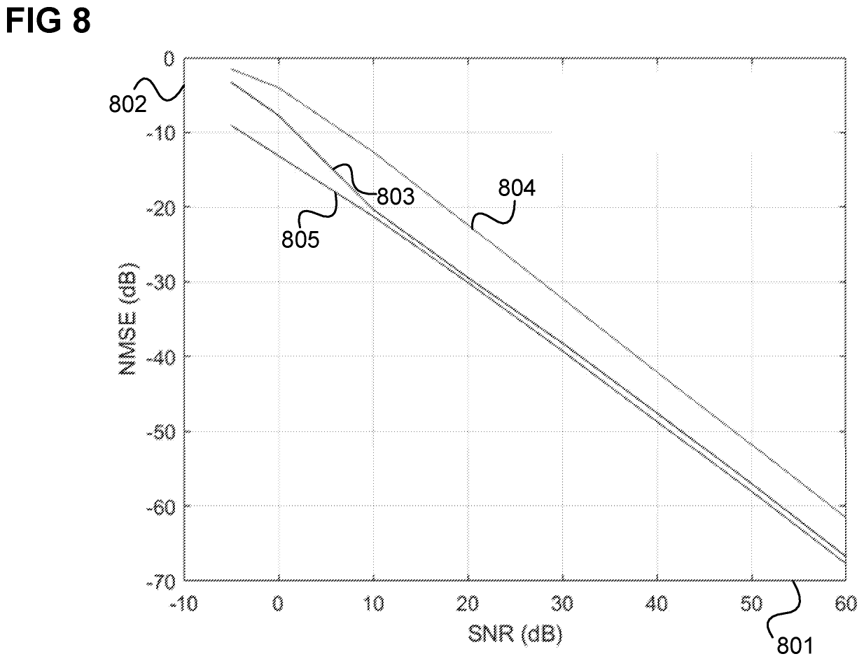

FIG. 8 illustrates performance results when using the PDP estimation approach described above in terms of normalized mean square error for denoising received pilot symbols in an LTE set-up (and denoising per OFDM symbol).

Mean squared error is indicated along the vertical axis 801 and signal-to-noise-ratio is indicated along the horizontal axis 802. The denoising gain for EPA channel model is shown. The delay spread of EPA is about 8% of LTE CP length.

Simulation parameters are set as follows. Bandwidth is 1.44 MHz, spanned over 96 sub-carriers, having sub-carrier frequency of 15 KHz. There are 24 pilots spaced 4 sub-carriers apart. The cyclic prefix (CP) duration is 5.2083 micro second. As shown in FIG. 8, the proposed Maximum Likelihood PDP estimation approach (center graph 803) provides more denoising gain than the Fixed Wiener filter (top graph 804) over all SNR ranges. Up to 8 dB more denoising gain can be observed at 10 dB SNR. Compared to the ideal Wiener filter (bottom graph 805) that requires perfect knowledge of PDP, the Maximum Likelihood PDP estimation approach is only about 1.5 dB worse above 10 dB SNR.

At 10 dB SNR, the Maximum Likelihood PDP estimation approach provides 4.8 dB gain over the Fixed Wiener Filter and 2.9 dB gain over a matched filter method. Similarly, at 60 dB SNR, the Maximum Likelihood PDP estimation approach has 3.6 dB gain and 3.2 dB gain over the Fixed Wiener filter and matched filter, respectively. Compared to the ideal Wiener Filter, the Maximum Likelihood PDP estimation approach consistently performs about 1.5 dB worse above 10 dB SNR, which means there is no error floor at high SNR.

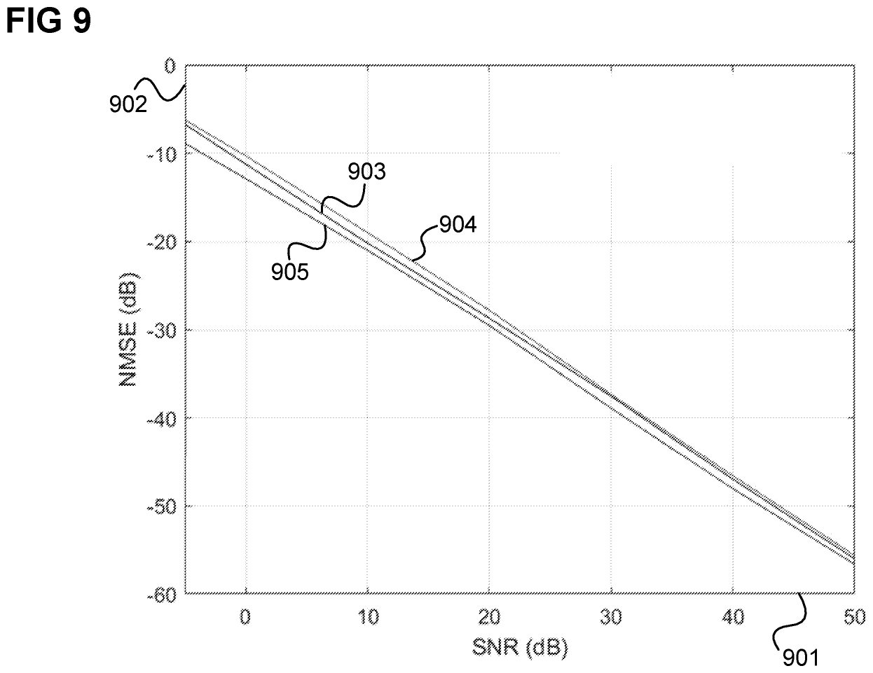

FIG. 9 illustrates performance results when using the Maximum Likelihood PDP estimation approach described above in terms of normalized mean square error for denoising received pilot symbols in a WiFi set-up (and denoising per OFDM symbol).

Mean squared error is indicated along the vertical axis 901 and signal-to-noise-ratio is indicated along the horizontal axis 902. The denoising gain for EPA channel model is shown. The delay spread of EPA is about 52% of WiFi HE-LTF CP length.

Simulation parameters are set as follows. Bandwidth is 20M MHz, spanned over 256 sub-carriers, having sub-carrier frequency of 78.125 KHz. Long training field (HE-LTF) of length 12.8 micro seconds is used for channel estimation. There are 242 pilot sub-carriers, contiguous from subcarriers −121 to −2, and from subcarriers +2 to +121. The cyclic prefix (CP) duration is 0.8 micro second.

Sub-carriers are partitioned into blocks of 49 contiguous subcarriers for minimizing denoising complexity. Sample covariance of 49 contiguous subcarriers is averaged over all the blocks as described by Eq. (9) above. FIG. 9 compares the NMSE performance for ideal Wiener (bottom graph 905), Fixed Wiener filter (top graph 904) and the Maximum Likelihood PDP estimation approach (center graph 903).

As the delay spread of EPA is almost half the CP duration, the gain of the Maximum Likelihood PDP estimation approach over the Fixed Wiener filter is small. Nonetheless, the loss from ideal Wiener Filter is about 1 dB.

While the estimation of PDP by directly numerically solving the maximum likelihood problem as described gives good results, it also incurs a large computational cost as it requires performing inversions and determinant calculations on matrices. This may limit its application in real-time signal processing.

Therefore, according to various embodiments, the receiver of a transmission (corresponding to the receiving side of the communication devices 101, 102 for the transmission) utilizes a neural-network based architecture for solving constrained optimization problems, in particular Eq. (8). The neural network allows learning to compute the maximum-likelihood estimate of the power delay profile (PDP) for wireless multi-path channel using one OFDM symbol. The Maximum likelihood PDP estimation ground truth for training can be determined using the numerical algorithm described above with low effort. It should be noted that training a neural network directly for channel estimation (i.e. to output impulse responses) because the true impulse response is unknown unless it is measured with very high effort.

Using pilot sub-carriers received from a single OFDM symbol as input data, the neural network computes the maximum-likelihood estimate of the PDP. The underlying Lagrangian multiplier constraint on the PDP estimate is embedded into the neural network architecture model via an auxiliary output variable that drives the solution towards a global minimum.

This neural network-based PDP estimation approaches provides performance close to the bound of non-neural network-based Maximum Likelihood PDP estimation algorithm described above, i.e. the PDP estimation by directly numerically solving the Maximum Likelihood problem, at a much lower complexity. Furthermore, mismatch and overfitting issues can be avoided. The performance gain is consistent across varying channel statistics and SNR values. The approach can directly be applied in pilot patterns for LTE/LTE-A as well as WiFi 802.11 versions.

The approach can be seen to make use of the techniques to introduce domain knowledge about a problem to be solved into a neural network architecture for solving the problem, in particular the usage of an additional output variable and splitting.

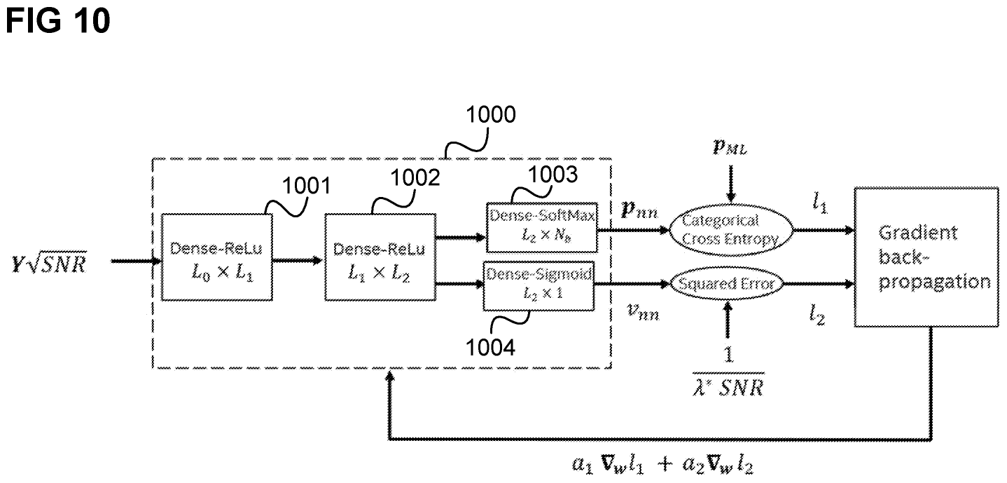

FIG. 10 illustrates the training of a neural network 1000 for maximum likelihood estimation of PDP (for an arbitrary channel delay profile).

The neural network's input layer has L₀=2Q number of neurons, where Q is the number of pilot sub-carries as defined in Eq. (1). Real and imaginary parts of received signal Y scaled by SNR is applied at the input.

The neural network 1000 includes a first hidden layer 1001 having L₁ and a second hidden layer 1002 having L₂ neurons. For example, L₁=L₂=40. Each hidden layer uses ReLu as activation function.

The neural network's output layer is bifurcated into two parts 1003, 1004: the first part 1003 is a dense layer with SoftMax activation function that computes the PDP estimate pₙₙ, which is a vector with N_{b} number of elements. The second part 1004 is another dense layer with Sigmoid activation function that computes a scalar value vₙₙ corresponding to reciprocal of Lagrangian multiplier.

The training is performed offline using training data (Y, SNR, p_{ML}, λ*) generated as follows:
1. Generate arbitrary power delay profile of a wireless multipath channel having attributes as follows:
   a. Number of channel taps are random integers between 1 and 20
   b. The variance of each channel tap is a real number uniformly and independently distributed between 0 and 1, and normalized by the sum of variances of all taps to have unity power.
   c. The amplitude of each channel tap is a zero-mean complex valued Gaussian random variable with its respective variance as given in 1b.
   d. The delay of each channel tap is a real number uniformly and independently distributed between 0 and t_{CP}.
2. Using the channel model described in 1, generate received pilot sub-carriers Y based on required OFDM numerology (such as LTE or WiFi) for different SNR values that are distributed uniformly between −10 dB to 60 dB.
3. Based on the PDP estimation using numerical direct solving of the Maximum Likelihood problem described above, compute the maximum likelihood estimate of the PDP p_{ML} and the solution to Lagrangian multiplier λ*≥0.
4. Discard all the training data with λ*=0

The neural network 1000 has the two outputs pₙₙ and vₙₙ and correspondingly there are two different losses with regard to two target outputs of each training data element. With the training data generated as described above, for each training data element,
the input is: Y\sqrt{SNR}
the first target output is p_{ML}. The categorical cross-entropy loss function for the first output is:

l₁=−Σ_{b=0}^{N}^{_{b}}⁻¹p(b)log pₙₙ(b)
the second target output is 1/λ*SNR. The squared error loss function for the second output is:

$${l}_{2} = {\vert \frac{1}{{λ}^{*} SNR} - {v}_{n n} \vert}^{2}$$

The training process trains the neural network by back-propagation: it calculates the gradients for both of these loss terms and weighs them by scalars a₁ and a₂ to compute the overall gradient ∇_{w}=a₁∇_{w}l₁+a₂∇_{w}l₂, according to which it adjusts corresponding weights and biases w of different layers of the neural network 1000.

When the neural network hast been trained (i.e. the neural network parameters w have been set), the neural network is loaded into the communication devices 101, 102 which allows the communication devices 101, 102 to perform inference using the trained neural network, i.e. compute the maximum likelihood estimate of the PDP by supplying Y\sqrt{SNR} for a received signal to the neural network and obtaining pₙₙ. The neural network also outputs vₙₙ, i.e.

$$\frac{1}{{λ}^{*} SNR} ,$$

which the receiver does not (necessarily) use. It can thus be seen as an auxiliary output for injecting domain knowledge as described above. This extra output greatly improves the performance: it can be achieved that there is no error floor and no mismatch effect, i.e. there is high robustness even for channels not represented in the training data.

However, during the inference, the neural network output pₙₙ can have small residual noise. These tiny errors get amplified at high SNR like around 60 dB, which may lead to performance loss. By refining the output PDP, utility can further be improved.

As a first PDP refinement method, the respective communication device may define a threshold based on the maximum output power of the PDP, and set all the taps below the threshold to be 0. More precisely,

$$Prefine ( b ) = \{ \begin{matrix}0 , & if {p}_{nn} ( b ) < \text{.05} {p}_{max} \\ {p}_{nn} ( b ) , & else\end{matrix}$$

where

$${p}_{max} = {max}_{b} {p}_{n n} ( b ) .$$

Finally, the communication device normalizes the refined PDP as:

$$Prefine ( b ) = \frac{Prefine ( b )}{{\sum }_{b} Prefine ( b )} .$$

As a second refinement method (at the cost of some added computational complexity) the communication device can refine the output PDP based on the Lagrangian multiplier output of the neural network. The thresholding step can be designed based on the fact that the NN outputs pₙₙ, vₙₙ should satisfy the Karush Kuhn Tucker (KKT) condition. In particular,

$$Prefine ( b ) = \{ \begin{matrix}0 , & if \vert trace ( ( {I}_{Q} - {K}_{n n}^{- 1} {YY}^{′} ) {{K}_{nn}}^{- 1} {R}_{b} ) - \frac{1}{{v}_{n n} S N R} \vert > δ \\ {p}_{n n} ( b ) , & else\end{matrix}$$

where

$${K}_{n n} = {\sum }_{b = 0}^{{N}_{b} - 1} {p}_{n n} ( b ) {R}_{b} + \frac{1}{SNR} {I}_{Q} ,$$

R_{b} is defined as in Eq. (2), and δ>0 is a hyper parameter. Lastly, the communication devices normalizes the refined PDP as:

$$Prefine ( b ) = \frac{Prefine ( b )}{{\sum }_{b} Prefine ( b )} .$$

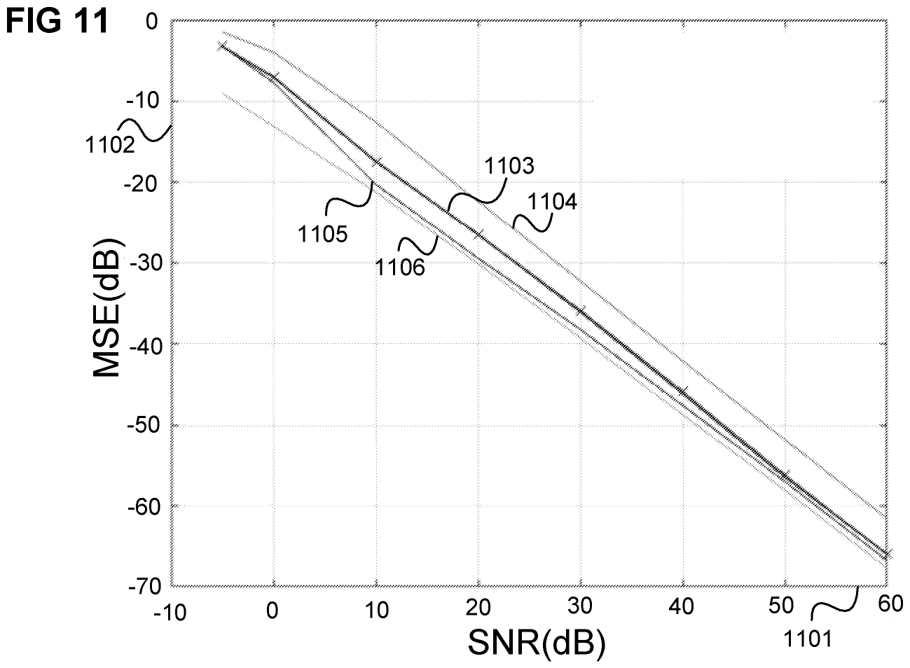

FIG. 11 illustrates performance results when using the PDP estimation approach described above in terms of normalized mean square error for denoising received pilot symbols in an LTE set-up (and denoising per OFDM symbol).

Mean squared error is indicated along the vertical axis 1101 and signal-to-noise-ratio is indicated along the horizontal axis 1102. The denoising gain for EPA channel model is shown. The delay spread of EPA is about 8% of LTE CP length.

Simulation parameters are set as follows: bandwidth is 1.44 MHz, spanned over 96 sub-carriers, having sub-carrier frequency of 15 KHz. There are 24 pilots spaced 4 sub-carriers apart. The cyclic prefix (CP) duration is 5.2083 micro second. The neural network design parameters are:

L₀=48, L₁=40, L₂=40, N_{b}=80, a₁=1, a₂=1. The second PDP refinement method is used.

In FIG. 11, the mean squared error (MSE) performance of different denoising techniques for EPA channel model is compared. The neural network-based approach described above (“NN method”, top center graph 1103) provides more denoising gain than Fixed Wiener filter (top graph 1104) over all SNR ranges. Up to 6 dB more denoising gain can be observed at 10 dB SNR. Further, the performance of the NN method is within 2 dB of the numerical direct Maximum Likelihood solution (bottom center graph 1105). The bottom graph 1106 gives the performance of the ideal Wiener filter. Simulations also show that the performance of the NN trained using input Y without any SNR scaling is just as good as the one that uses the scaled input Y\sqrt{SNR}.

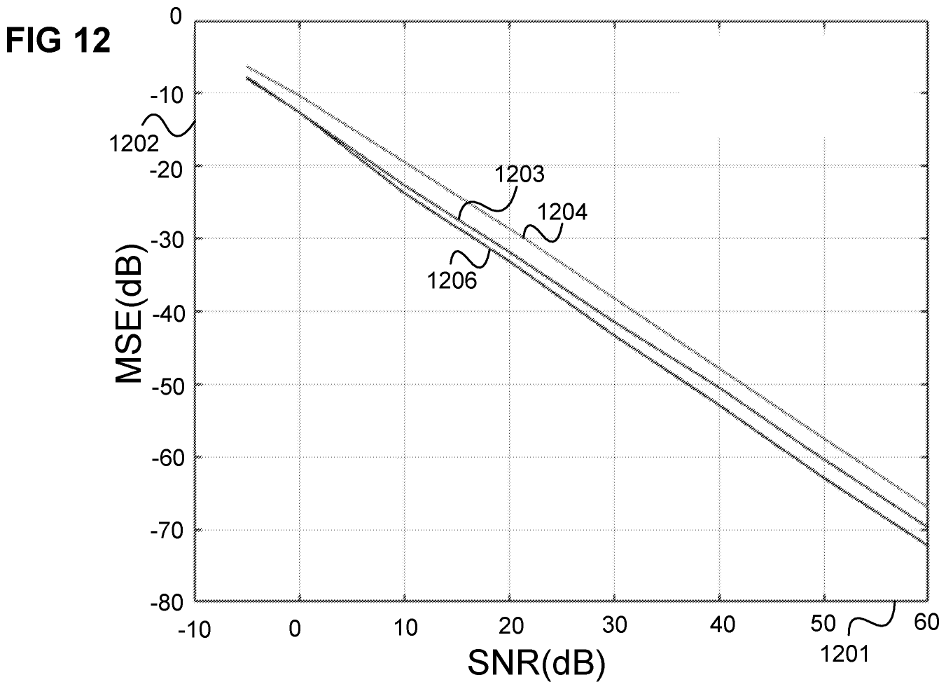

FIG. 12 illustrates performance results when using the PDP estimation approach described above in terms of normalized mean square error for denoising received pilot symbols in a WiFi set-up (and denoising per OFDM symbol).

Mean squared error is indicated along the vertical axis 1201 and signal-to-noise-ratio is indicated along the horizontal axis 1202.

Simulation parameters are set as follows: bandwidth is 20 MHz, spanned over 256 sub-carriers, having a sub-carrier frequency of 78.125 KHz. A long training field (HE-LTF) of length 12.8 micro seconds is used for channel estimation. There are 242 pilot sub-carriers, contiguous from subcarriers −121 to −2, and from subcarriers +2 to +121. The cyclic prefix (CP) duration is 0.8 micro second.

The neural network design parameters are: L₀=98, L₁=40, L₂=40, N_{b}=128, a₁=1, a₂=1. The first PDP refinement method is used. Sub-carriers are partitioned into blocks of 49 contiguous subcarriers for minimizing denoising complexity. Each block is passed through the neural network to estimate the PDP. The final PDP estimate is averaged over all blocks. FIG. 12 compares the MSE performance for different schemes. Each test data is generated using a single tap channel with uniformly and independently distributed delay between 0 and 0.8 micro second. The NN method (center graph 1203) outperforms the Fixed Wiener filter (top graph 1204) over all SNR ranges, and performs within 3 dB of the direct numerical solution of the maximum likelihood problem (bottom graph 1205), but at less than 10% of the computational complexity.

In the following, further examples of neural network-based approaches for determining characteristics of a wireless channel 105 are described which are based on the techniques described above for injecting domain knowledge into a neural network architecture.

Specifically, according to one approach described in the following, a receiver (corresponding to one of the communication device 101, 102 depending on which is currently acting as receiver, i.e. receives signals from the other), uses a neural network for channel estimation based on demodulation reference signals (DMRS). Accurate fast robust channel estimation based on DMRS is of high importance for implementing a wireless air interface to ensure robust and reliable wireless links in 3GPP (Third Generation Partnership Project) 5G (Fifth Generation), where DMRS are embedded in downlink and uplink data and control channels enabling timely estimation of the wireless channel 105. Channel estimation is typically an integral part of any wireless system. DMRS based channel estimates need to satisfy tight performance requirements, both in terms of small channel estimation errors and minimal computational complexity.

Channel estimation may be performed by linear and non-linear channel estimation techniques. The simplest form of channel estimation is least square channel estimation. Linear minimum mean squared error (LMMSE) based channel estimation imposes larger complexity but enables significantly better performance. Non-linear channel estimation techniques like maximum likelihood-based channel estimation techniques achieve even better performance than the linear approaches but typically impose prohibitive complexity requirements. Thus, those linear or non-linear channel estimation techniques either do not achieve good performance or require significant effort in estimating the statistics of the wireless channel and then fail if the channel statistics change, i.e. they are not able to strike a good balance between accuracy and required computational complexity.

Therefore, according to various embodiments, an artificial intelligence (or ML, specifically neural network)-based channel estimation technique is provided which provides a good balance between accuracy and computational complexity. In particular, it can take full advantage of forthcoming CPU instruction sets designed to accelerate AI (Artificial Intelligence) inference tasks and can thus be efficiently run on general-purpose platforms.

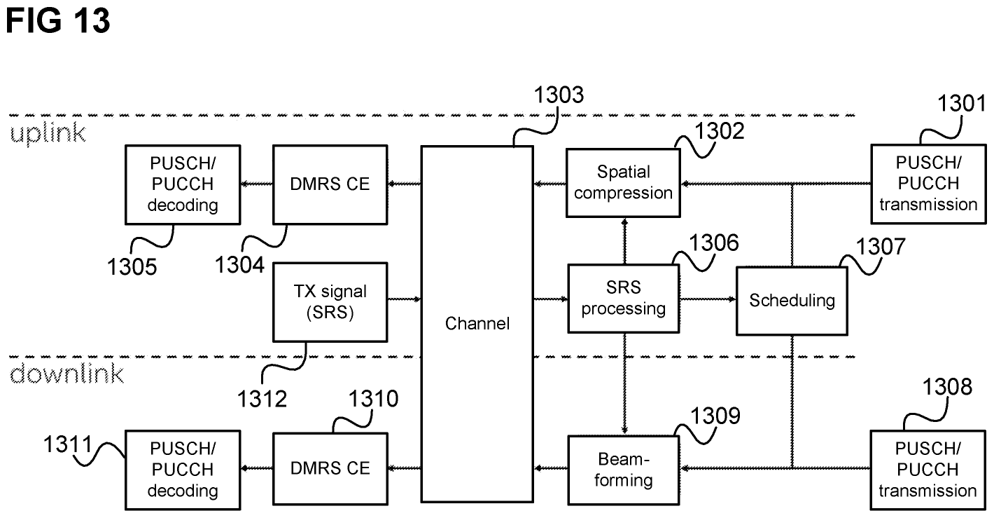

FIG. 13 depicts an overview of the uplink and downlink of a 3GPP 5G system.

In uplink the sending communication device (mobile terminal for the uplink) processes PUSCH (physical uplink shared channel) and PUCCH (physical uplink control channel) data 1301 by spatial compression 1302 and sends the compressed data via the wireless channel (corresponding to wireless channel 105). The receiving communication device (base station for the uplink) performs uplink DRMS-based channel estimation 1304 and, using the results, PUSCH and PUCCH decoding 1305, respectively.

Further, the mobile terminal sends an SRS signal 1312 via the channel 1303 to the base station which performs SRS processing 1306 and scheduling 1307 (of both uplink and downlink) accordingly.

In downlink, the sending communication device (base station) processes PDSCH (physical downlink shared channel) and PDCCH (physical downlink control channel) data 1308 by (SRS-based) beamforming and sends it via the channel 1303 to the receiving communication device (mobile terminal). The mobile terminal performs downlink DMRS-based channel estimation 1310 and, using the results, PDSCH and PDCCH decoding 1311, respectively.

According to various embodiments, the receiving communication device (base station in uplink, mobile terminal in downlink) which performs DRMS-based channel estimation 1304, 1310 uses the neural-network based approach for PDP estimation described above for calculating the PDP of the channel 1303.

The signal received on a number of DMRS carrying subcarriers can be written as vector r. After dividing by the known DMRS x the received signal can be written as Y=r/x=H+n. Given Y the receiver can calculate the PDP using the neural-network based approach for PDP estimation described above. The receiver may estimate the PDP also differently.

When it has estimated the PDP the receiver, according to various embodiments, performs an AI (or ML)-based channel estimation by calculating a channel estimation filter using a neural network.

The channel estimation filter is a linear filter

Ĥ=WY.

The filter produces a denoised channel estimate on the reference symbol subcarriers. Once the receiver has estimated the PDP, it uses the PDP estimate to compute the linear filter coefficients using a neural network. According to various embodiments, this involves PDP quantization.

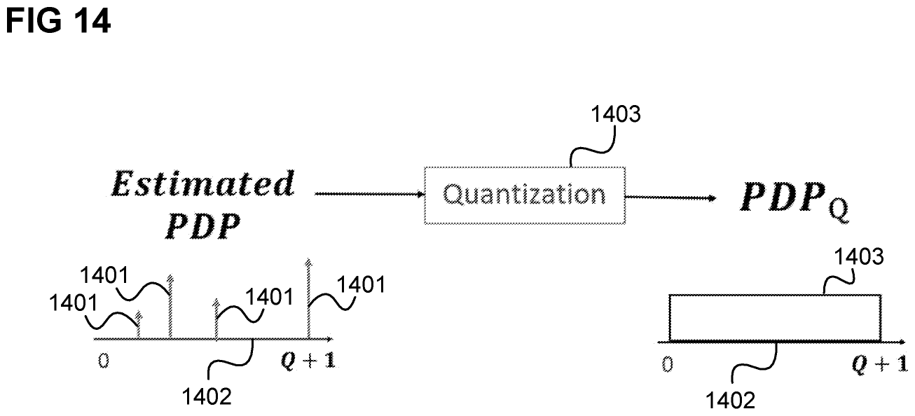

FIG. 14 illustrates a PDP quantization according to an embodiment.

An estimated PDP includes a plurality of delays indicated by arrows 1401 along a delay axis 1402 (delay increases starting from the origin from left to right). The maximum delay is denoted by Q+1. A PDP quantizer 1403 quantizes the estimated PDP to a quantized PDP 1403 denoted as PDP_{Q} wherein

$$P D {P}_{Q} = U ( 0 ) - U ( Q + 1 )$$

U is the unit step function. The maximum value of Q+1 is L, where L is the cyclic prefix length in samples. If a binary amplitude (of the arrows 1401) is used the total possibilities are 2^{L} for the estimated PDP. By the quantization, the possibilities are reduced to L since

$$Q + 1 = round ( max delay of Estimated PDP )$$

i.e. the PDP is quantized to one of L values where L is the total quantization of the cyclic prefix (i.e. the length of the cyclic prefix in samples).

According to various embodiments, the receiver, in addition to the PDP quantization, also uses SNR quantization. It quantizes the SNR to binary values depending upon whether the SNR is higher than a certain threshold or not.

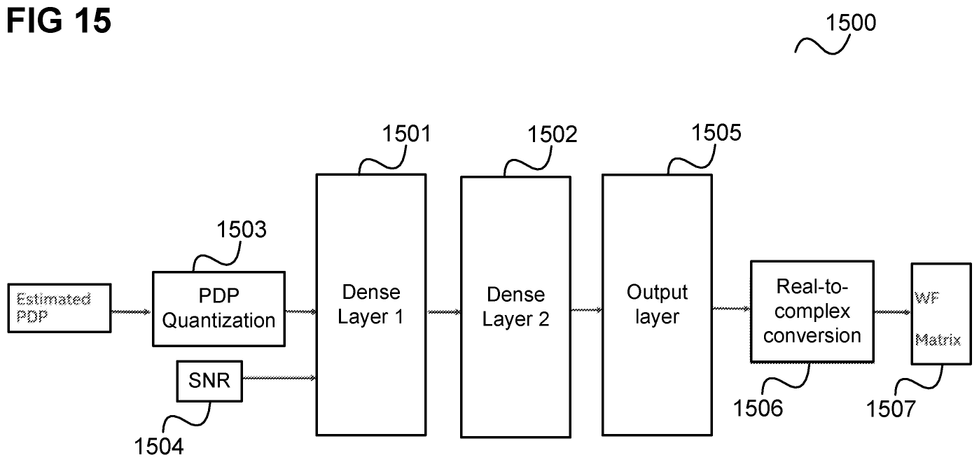

FIG. 15 shows a neural network 1500 according to an embodiment.

The neural network 1500 includes dense layers 1501, 1502, wherein the first dense layer 1501 receives the quantized PDP supplied by the PDP quantizer 1503 and the quantized SNR 1504. In this example, an output layer 1505 of the neural network 1500 provides a real output which is converted to a complex filter matrix 1507 by real to complex conversion 1506. The complex filter matrix 1507 defines the channel estimation filter which the receiver applies.

Thus, the neural network 1500 generates a linear filter corresponding to one of the 2L input possibilities (L possible PDPs, each for two possible values of the quantized SNR). Simulations show that the PDP and SNR quantization results in negligible loss in performance.

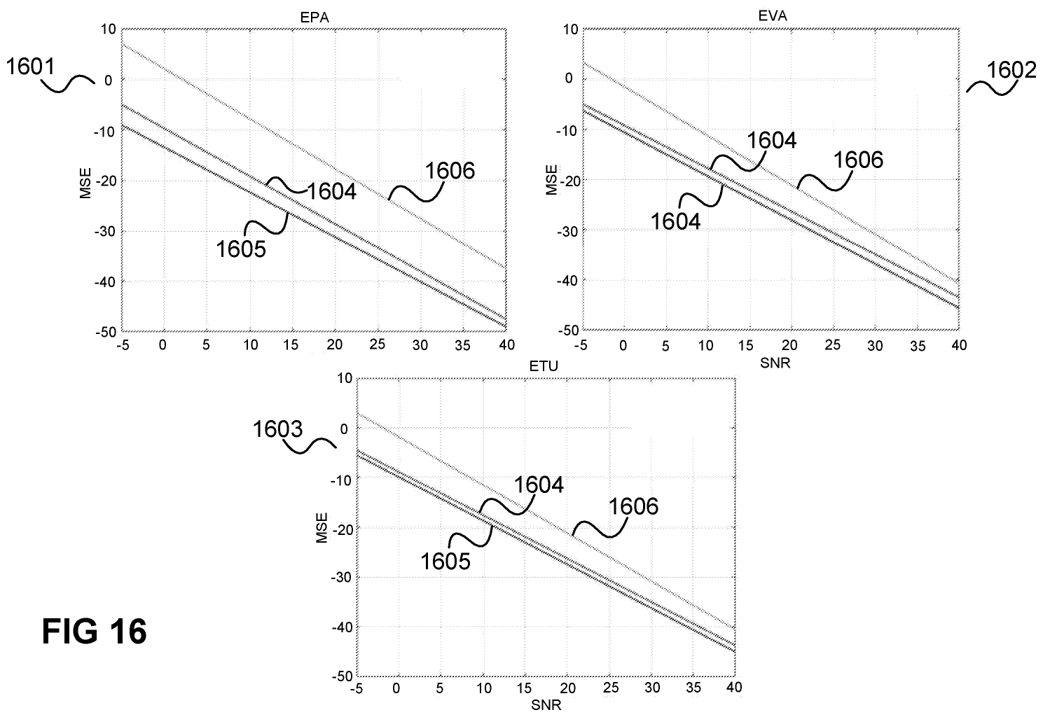

FIG. 16 shows three diagrams 1601, 1602, 1603 showing the performance of the neural network-based filter approach described above (center graph 1604) in comparison to an ideal Wiener filter (bottom graph 1605) and an LLMSE strategy (top graph 1606).

The diagrams 1601, 1602, 1603 show MSE over SNR for EPA, EVA (Extended Vehicular A) and ETU channel model, respectively.

In the LMMSE strategy the correlation matrix needed is computed by averaging over five OFDM symbols. That technique has similar complexity to the neural network-based filter approach described above but much worse performance.

In case the receiver uses the neural network-based PDP estimation approach above, this neural network (as well as the neural network 1500) may be trained offline as described above. The PDP estimation function (as well as the neural network 1500) can also be trained online given channel measurements from the current deployment. The ORAN standard provides a comprehensive framework for the collection of training data and deployment of trained models and may be used in combination with the approaches described herein.

The receiver can interpolate the channel estimate over time and frequency given Ĥ.

The receiver can generate channel estimates for multiple antenna ports by first estimating the channel for some reference antenna ports and then estimate the channel on the remaining antenna ports by interpolating the channel estimates from the reference antenna ports.

In the following, a ML-based approach for SRS processing 1306 is described. It provides a low complex AI-based framework to process sounding reference signals. The capabilities of general-purpose computer hardware are growing constantly, enabling execution of (near) real-time physical layer and baseband algorithms in software. At the same time, wireless systems are trending towards adding more and more antennas, which increases complexity of physical layer and base band algorithms. In particular, SRS processing is a computationally complex task.

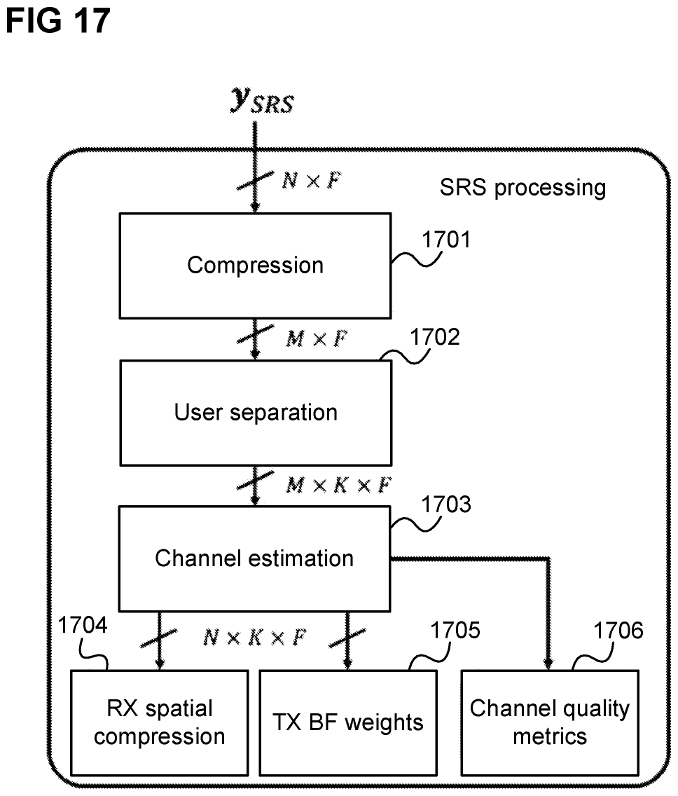

FIG. 17 illustrates an SRS processing flow.

The output of the SRS processing are beamforming weights, spatial compression weights, channel estimates as well as channel quality metrics (e.g. RSRP (Reference Signal Received Power), RSRQ (Reference Signal Received Quality), SINR (Signal to Interference Plus Noise Ratio).

It is assumed that K users collected in the index set [symbol] ={k₁, k₂, . . . , k_{K}} are scheduled to transmit the SRS signal 1312 on the same spectral resources. Let xₖ[ƒ] be the SRS transmitted by user k on subcarrier ƒ, then the received signal at the base station can be written as

$${y}_{SRS} [ f ] = {\sum }_{k ∈ 𝒦} {h}_{k} [ f ] {x}_{k} [ f ] + n .$$

where hₖ[ƒ] is the N dimensional channel vector (with N the number of base station antennas) from user k on subcarrier ƒ and n is additive receiver noise. It is further assumed that all users transmit SRS on F subcarriers collected in the index set [symbol] ={ƒ₁, ƒ₂, . . . , ƒ_{F}}.

In 1701, the base station performs compression: for massive MIMO, the received signal y is compressed from an N×F matrix to a M×F matrix z, with M≤N.

In 1702, the base station performs user separation: the received compressed signal z includes SRS signals from K transmitters. The user separation extracts signals from all transmitters and returns zₖ, for all k∈ [symbol] .

In 1703, the base station performs SRS channel estimation: estimation of the N dimensional channel vector by \tilde{h}ₖ for each transmitter k∈ [symbol] .

In 1704 and 1705, the base station performs RX (reception) spatial compression and TX BF weights calculation: given a scheduling decision [symbol] ⊆ [symbol] , calculation of RX spatial compression and/or TX beamforming weights for scheduled users k∈ [symbol] .

In 1706, the base station performs channel quality metric inference: inference of channel quality metrics like RSRP, RSRQ, SINR, etc.

Embodiments provide ML-based approaches for the above operations 1701-1706, wherein the operations may be addressed (and e.g. optimized) jointly or separately.

It should be noted that techniques to cancel or mitigate multiuser interference and/or estimate the channels of individual users can be divided in two main categories:
1. Frequency domain processing: SRS sequences defined in 3GPP are orthogonal over a set of n subcarriers. Hence, most multiuser interference can be canceled by correlating the received signal with the SRS sequence of the user of interest. However, frequency domain processing provides only a rough channel estimate. The resolution of the channel estimate is limited by the length of the SRS sequence n. Hence, the output is a step function with a step size of n. The resolution can be improved with an additional interpolation step, which adds significant computational complexity.
2. Time domain processing: after preprocessing (e.g. division by the base sequence) the SRS sequences defined in 3GPP result in a cyclic shift of a user's channel impulse response (CIR). Since each user is configured with a different cyclic shift, windowing can be used to separate user's CIR respond in time domain. However, after receiving the signal in frequency domain at the base band processing functional block, two additional FFTs are required. Hence, the complexity is high. Furthermore, the time domain window needs to be selected based on current channel conditions like SNR and delay spread. Performance quickly degrades if the window is not accurately placed.

In contrast to these two categories, the receiver uses an ML model trained to perform joint user separation and channel estimation from SRS signals. The ML model can be trained offline based on training signals (e.g. designed to maximize generalization, i.e. to achieve universal training). Embodiments also allow for deployment specific online training, which further improves overall performance. Embodiment may directly estimate RX spatial compression or TX beamforming weights (from received SRS signals). Moreover, additional outputs can be added to infer channel quality metrics.

Thus, according to various embodiments, (scalable) joint user separation and channel estimation is performed by a low complex ML model. Channel estimation accuracy is significantly improved over base line solutions. Specifically, high robustness is achieved (for different SNR and different propagation channel conditions) at low complexity (in particular in comparison to time domain processing approaches, see above).

According to various embodiments, the ML model is implemented by a (feedforward) neural network. A training process (executed by a computer) may train the neural network using labeled data (i.e. training data including training data elements which each include a training input and a target output (ground truth)). To account for a wide range of channels that may be encountered in practice, the training process may train the ML model with channel realizations that are characterized by a random Power Delay Profile (PDP) with number of taps that may be uniformly distributed between 1 and a maximum value. In addition, the training process may add available measured deployment specific training data.

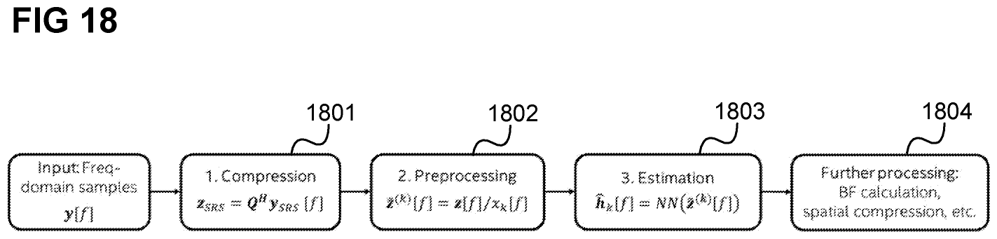

FIG. 18 illustrates a neural network-based SRS processing according to an embodiment.

The input are frequency domain samples 1801.

As in the processing of FIG. 17, the receiver uses an initial compression 1801 to reduce the problem size and overall computational complexity. The received signal y_{SRS} is compressed in the spatial domain, i.e., N physical antennas are compressed to M virtual antennas, yielding

z_{SRS}[ƒ]=Q^{H}y_{SRS}[ƒ]

The compression matrix Q can be calculated in various ways. Ideally, it may depend on the sample covariance matrix of y_{SRS}. The initial compression may also be omitted. That is equivalent to setting Q=I, with I the identity matrix.

The compression is followed by a pre-processing 1802: for user k∈ [symbol] , this includes the computation:

$${\tilde{z}}^{( k )} [ f ] = \frac{{z}_{SRS} [ f ]}{{x}_{k} [ f ]}$$

where xₖ[ƒ] is the transmitted SRS signal from user k.

Then, a neural network 1803 receives the signal \tilde{z}^{(k)}[ƒ] and processes it to perform user separation and channel estimation. The neural network 1803 has been trained to minimize the MSE [symbol] ∥ĥₖ[ƒ]−hₖ[ƒ]∥₂² between the true channel response h_{k[ƒ]} and the neural network output ĥₖ[ƒ]. It should be noted that the neural network is trained to output a full dimensional channel vector from a compressed input vector.

Thus, the SRS processing of FIG. 18 processes y_{SRS}[ƒ] to derive a channel estimate ĥₖ[ƒ] for all users k∈ [symbol] and all subcarriers ƒ∈ [symbol] . These results may be processed by a post-processing 1804 like BF (beamforming) calculation, spatial compression, etc.

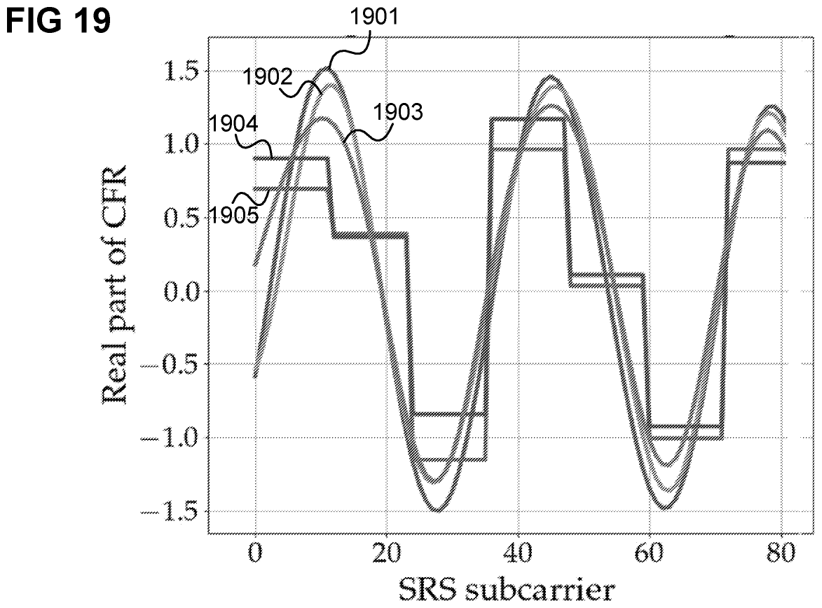

FIG. 19 illustrates results of a frequency-domain channel estimation for a single channel realization.

It compares the true channel (outer graph 1901) with the result of time-domain processing (inner graph 1902) and the neural network-based SRS processing described above (inner graph 1903) as well as the result of a frequency processing estimate (top piecewise linear graph 1904) and the averaged ideal channel with a resolution of 12 sub-carriers (bottom piecewise linear graph 1905).

The results show that shows that the neural network-based SRS processing and the time domain processing can track the ideal channel well. The frequency domain processing is only able to produce a step function and requires further processing.

According to one embodiment, the neural network 1803 is trained to output a compressed channel estimate. That is \hat{z}ₖ[ƒ]=NN(\tilde{z}^{(k)}[ƒ]), with \hat{z}ₖ[ƒ] a M dimensional vector. The receiver can then recover the full dimensional channel estimate by computing ĥₖ[ƒ]=ƒ(\hat{z}ₖ[ƒ]), where may be realized by ƒ(x)=Q^{H}x or another function.

According to one embodiment, a training process trains the neural network 1803 to estimate the channel averaged over multiple subcarriers.

According to one embodiment, a training process trains the neural network 1803 to output RX spatial compression weights for each user.

According to one embodiment, a training process trains the neural network 1803 to output TX beamforming weights for each user.

According to one embodiment, a training process trains the neural network 1803 to output channel quality metrics.

According to one embodiment, the neural network 1803 is realized through a recurrent neural network enabling efficient exploitation of temporal correlations in the channel (this applies to all of the possible outputs of the neural network described above).

In the following, results of a performance comparison of the neural network-based SRS processing (with compression) and (i) time domain processing with windowing, (ii) frequency domain processing and (iii) ideal averaging in frequency domain (performance upper bound for frequency domain processing) is given. It is shown that deployment-specific training can have an improvement over a purely random channel-based ML model.

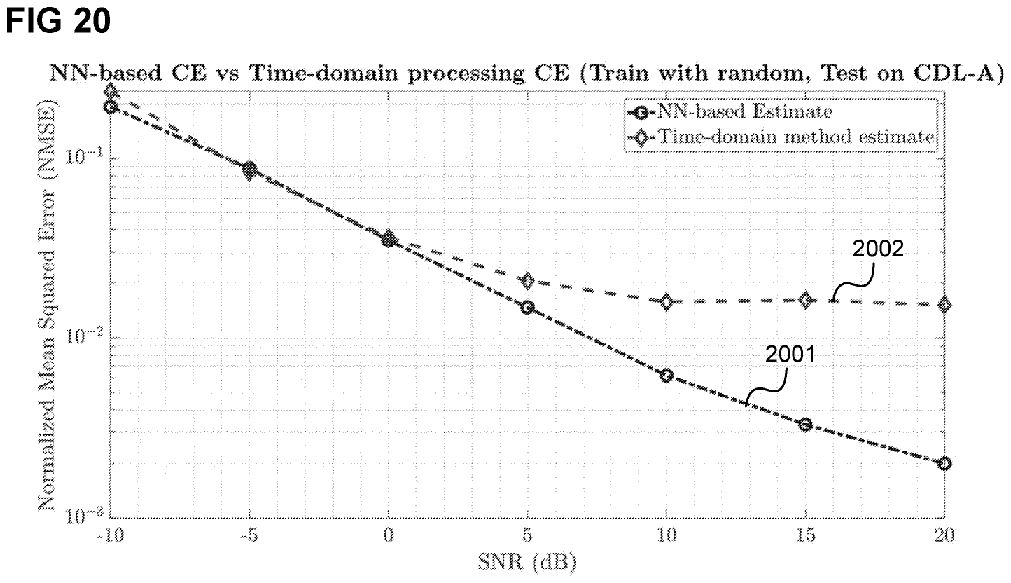

FIG. 20 shows a comparison of the performance of the neural network-based SRS processing (bottom graph 2001) and time domain processing (2002), wherein the neural network is trained at each SNR point from −10 to 20 dB using only random PDP channel realizations described above, and then tested at each SNR with channels drawn from the CDL-A profile.

To demonstrate the performance improvements of the neural network-based SRS channel estimation over the existing time-domain processing approach, an ML model is first trained and tested at a single SNR. The channel realizations used for training include those from the Clustered Delay Line (CDL) profiles, from CDL-A to CDL-E. The test set includes channel realizations independent from the training set.

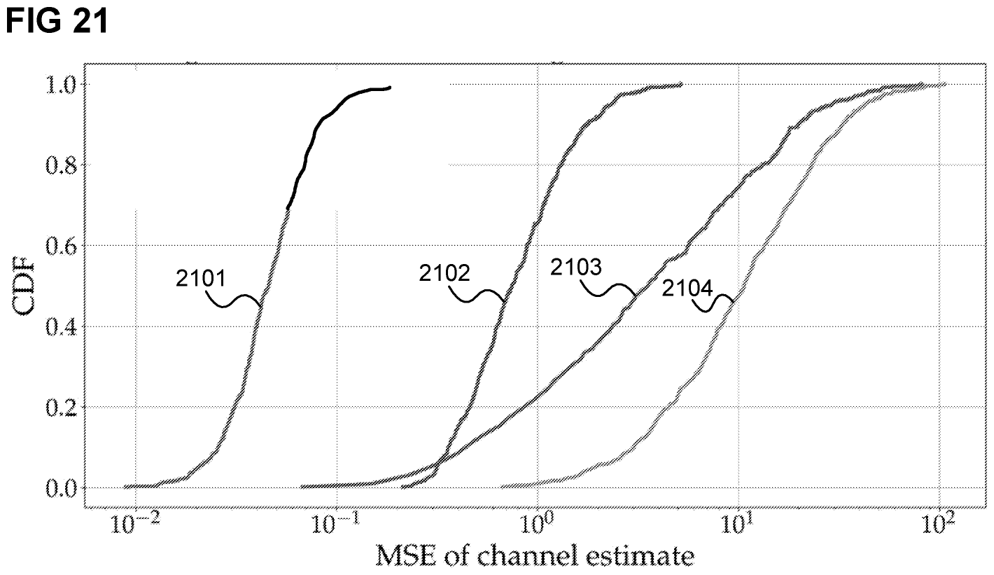

FIG. 21 shows the Cumulative Distributive Function (CDF) of the channel estimation Mean Squared Error (MSE) measured over 500 channel realizations for the neural network-based SRS processing (left graph 2101), time domain processing (second to left graph 2102), average ideal channel with resolution of 12 sub-carriers (second to right graph 2203) and frequency domain processing (right graph 2204). This evaluation is for a received Signal-to-Noise Ratio (SNR) of 0 dB. The channel model is the CDL-A model. On average, the neural network-based estimation method provides a 12 dB improvement over the time-domain processing approach.

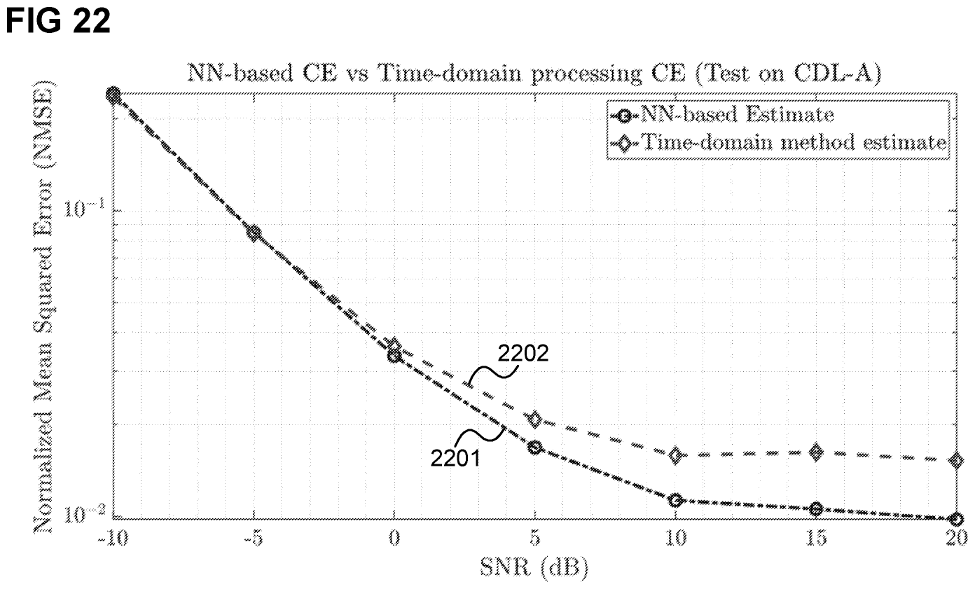

Since SRS channel estimation can be expected to be implemented for a wide range of received SNR, it is desirable to have a single neural network that can provide performance at par or better than the other approaches. To this end, the neural network described above is trained over an SNR range of −10 to 20 dB. To ensure robustness of the neural network-based SRS processing, instead of training the neural network on standard defined channel profiles such as TDL or CDL, the neural network is trained on channel realizations with a random power delay profile (PDP). In this random channel profile, the training process selects both the number of impulse response taps as well as their positions randomly from a uniform distribution [symbol] (0, N_{cp}−1), where N_{cp} is the length of the Cyclic Prefix (CP) used in the OFDM setup. The performance of the neural network trained in this manner over this SNR range for the CDL-A channel profile is illustrated in FIG. 22.

FIG. 22 shows a comparison of the performance of the neural network-based SRS processing (bottom graph 2201) and time domain processing (top graph 2202) wherein the neural network is trained for the whole SNR range.

The neural network-based estimation method performs as well as the time-domain processing method in the low SNR regime (−10 to 0 dB) and outperforms it in the medium to high SNR range (5 to 20 dB).

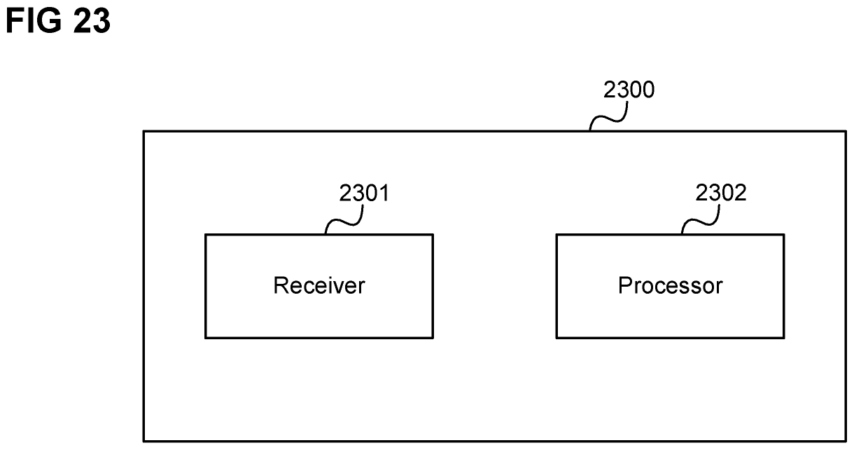

In summary, according to various embodiments, a communication device is provided as illustrated in FIG. 23.

FIG. 23 shows a communication device 2300 according to various embodiments.

The communication device 2300 includes a receiver 2301 and a processor 2302.

According to one embodiment, the receiver 2301 is configured to receive a signal from another communication device via a radio channel and the processor 2302 is configured to determine a channel characteristic of the radio channel using a neural network configured a neural network in accordance with domain knowledge regarding the determination of the channel characteristic.

According to various examples, in other words, domain knowledge is injected into the neural network architecture used to determine a channel characteristic.

According to one embodiment, the receiver 2301 is configured to receive a signal from another communication device via a radio channel and the processor 2302 is configured to estimate a power delay profile of the radio channel by maximum likelihood estimation of the power delay profile from the received signal and perform receive signal processing in accordance with the estimated power delay profile.

According to various examples, in other words, a power delay profile is estimated by searching a solution of a maximum likelihood estimation, i.e. searching for a power delay profile which maximizes the likelihood that the received signal is received as it was received.

According to various embodiments, the receiver 2301 is configured to receive a signal from another communication device via a radio channel and the processor 2302 is configured to control a neural network to output, for an input signal, a power delay profile and a representation of a Lagrangian multiplier of a maximum likelihood estimation of the power delay profile from the input signal, supply an input to the neural network in accordance with the received signal and perform receive signal processing in accordance with a power delay profile output by the neural network in response to the input.

According to various examples, in other words, a neural network is trained for estimating a power delay profile in accordance with a maximum likelihood estimation of the power delay profile. This is done by training the neural network also to output a suitable Lagrangian multiplier (or a representation of it, e.g. a (scaled) reciprocal) for the maximum likelihood estimation, i.e. indicate the value of the Lagrangian multiplier at the solution (i.e. the estimated power delay profile) of a maximum likelihood estimation problem for estimating the power delay profile.

According to various embodiments, the receiver 2301 is configured to receive a signal from another communication device via a radio channel and the processor 2302 is configured to control a neural network to determine channel estimation filters from power delay profiles, determine a power delay profile of the radio channel from the received signal, supply the determined power delay profile to the neural network and perform signal filtering in accordance with a representation of a channel estimation filter output by the neural network in response to being supplied with the determined power delay profile.

According to various examples, in other words, a neural network is trained to determine a channel estimation filter, i.e. coefficients of a channel estimation filter for processing a received signal, from an estimate of the power delay profile of the channel via which the signal is received.

According to various embodiments, the receiver 2301 is configured to receive a superposition of sounding reference signals sent by a plurality of other communication devices and the processor 2302 is configured to control a neural network to determine communication signal processing control information from receive signals, supply an input according to the received superposition of sounding reference signals to the neural network and perform radio communication signal processing in accordance with communication signal processing control information output by the neural network in response to the input.

According to various examples, in other words, a neural network is trained to determine communication signal processing control information (e.g. channel estimation information, beamforming coefficients, etc.) from a received signal which contains sounding reference signals sent by a plurality of communication devices (i.e. users).

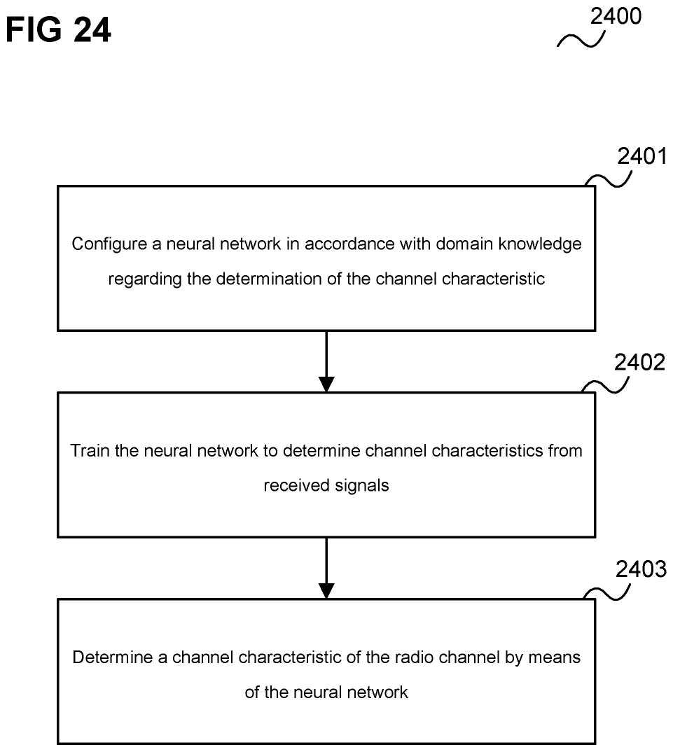

According to one embodiment, a method is performed as illustrated in FIG. 24.

FIG. 24 shows a flow diagram 2400 illustrating a method for determining a channel characteristic.

In 2401, a data processing and communication arrangement configures a neural network in accordance with domain knowledge regarding the determination of the channel characteristic.

In 2402, the data processing and communication arrangement trains the neural network to determine channel characteristics from received signals.

In 2403, the data processing and communication arrangement determines a channel characteristic of the radio channel using the neural network.

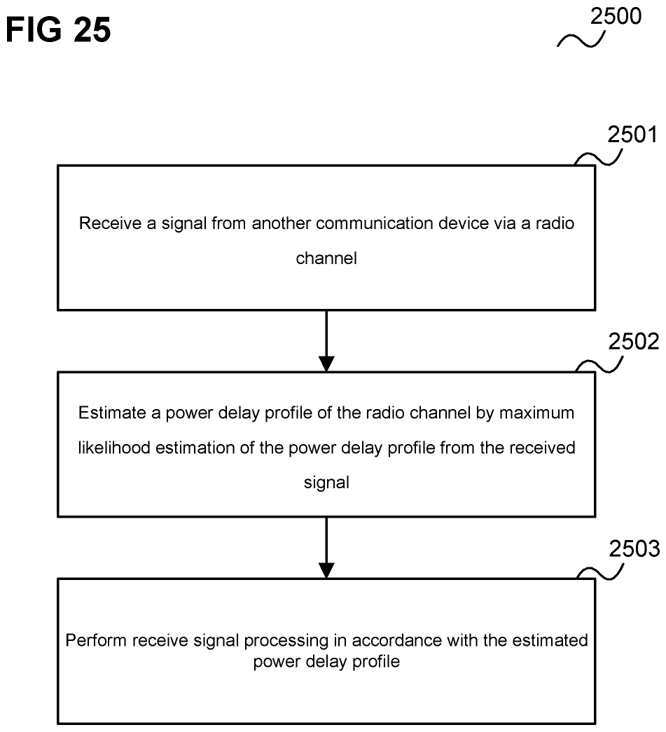

According to one embodiment, the communication device 2300 performs a method as illustrated in FIG. 25.

FIG. 25 shows a flow diagram 2500 illustrating a method for performing receive signal processing.

In 2501, a communication device receives a signal from another communication device via a radio channel.

In 2502, the communication device estimates a power delay profile of the radio channel by maximum likelihood estimation of the power delay profile from the received signal.

In 2503, the communication device performs receive signal processing in accordance with the estimated power delay profile.

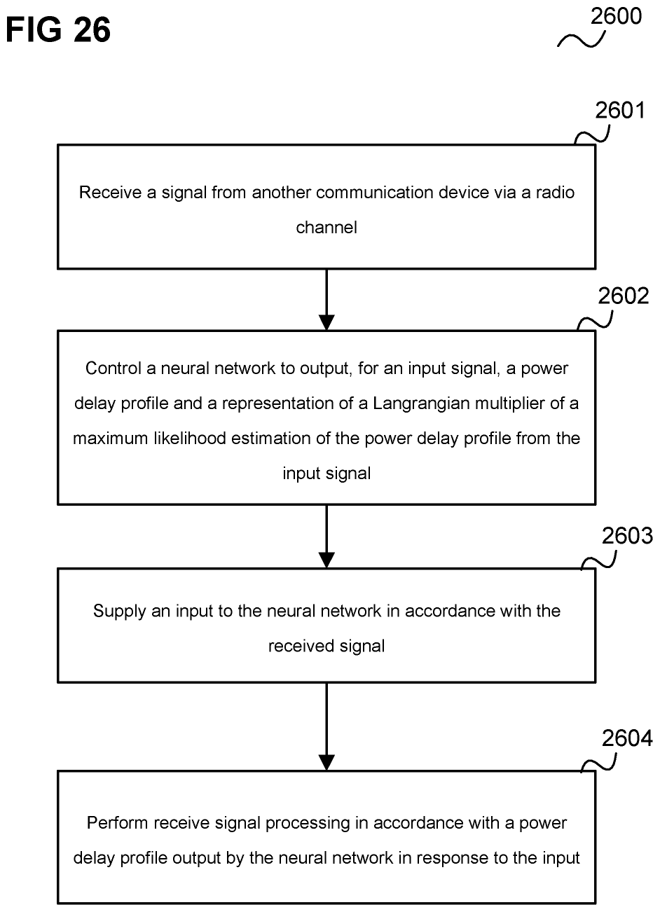

According to one embodiment, a method is performed as illustrated in FIG. 26.

FIG. 26 shows a flow diagram 2600 illustrating a method for performing receive signal processing.

In 2601, a communication device receives a signal from another communication device via a radio channel.

In 2602, the communication device controls a neural network to output, for an input signal, a power delay profile and a representation of a Lagrangian multiplier of a maximum likelihood estimation of the power delay profile from the input signal.

In 2603, the communication device supplies an input to the neural network in accordance with the received signal.

In 2604, the communication device performs receive signal processing in accordance with a power delay profile output by the neural network in response to the input.

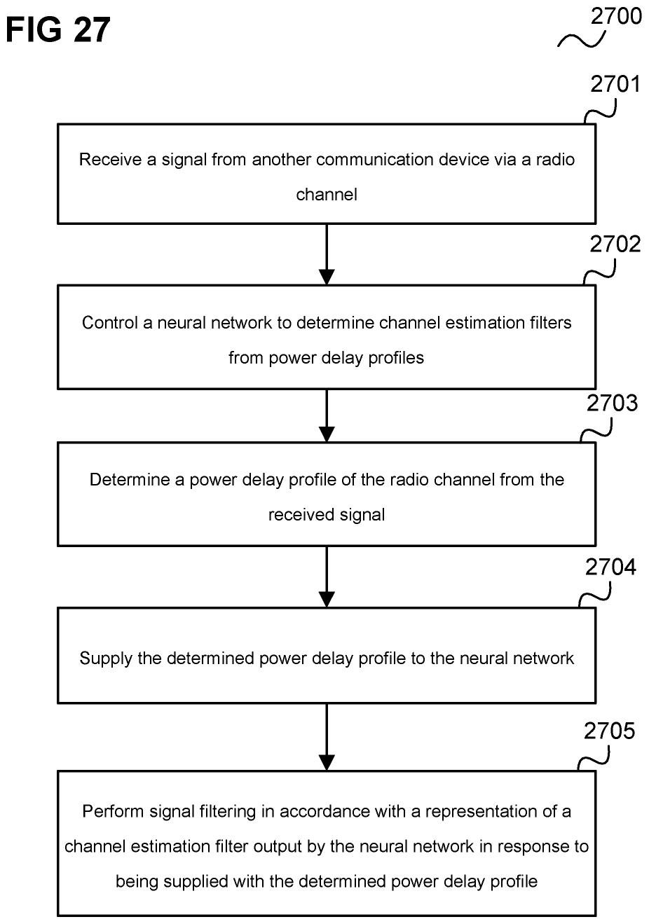

According to one embodiment, a method is performed as illustrated in FIG. 27.

FIG. 27 shows a flow diagram 2700 illustrating a method for filtering a signal received via wireless communication.

In 2701, a communication device receives a signal from another communication device via a radio channel.

In 2702, the communication device controls a neural network to determine channel estimation filters from power delay profiles.

In 2703, the communication device determines a power delay profile of the radio channel from the received signal.

In 2704, the communication device supplies the determined power delay profile to the neural network.

In 2705, the communication device performs signal filtering in accordance with a representation of a channel estimation filter output by the neural network in response to being supplied with the determined power delay profile.

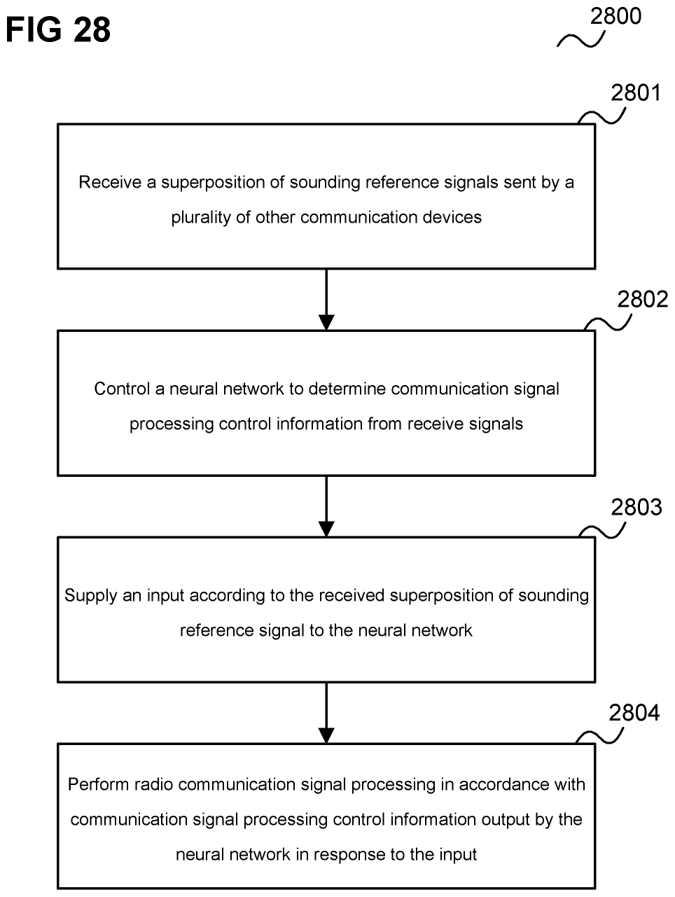

According to one embodiment, a method is performed as illustrated in FIG. 28.

FIG. 28 shows a flow diagram 2800 illustrating a method for performing radio communication signal processing.

In 2801, a communication device receives a superposition of sounding reference signals sent by a plurality of other communication devices.

In 2802, the communication device controls a neural network to determine communication signal processing control information from receive signals.

In 2803, the communication device supplies an input according to the received superposition of sounding reference signals to the neural network.

In 2804, the communication device performs radio communication signal processing in accordance with communication signal processing control information output by the neural network in response to the input.

According to various embodiments, computer program elements and computer readable media including instructions which, when executed by a processor, to perform a method according to any embodiment and example described herein, may be provided.

The components of the communication devices may for example be implemented by one or more processors. Similarly, the training process for (offline) training of a neural network may be implemented by one or more processors (e.g. of a computer which may be separate from the communication device onto which the trained neural network is loaded for (online) usage). A “processor” may be understood as any kind of a logic implementing entity, which may be special purpose circuitry or a processor executing software stored in a memory, firmware, or any combination thereof. Thus a “processor” may be a hard-wired logic processor or a programmable logic processor such as a programmable processor, e.g. a microprocessor. A “processor” may also be a processor executing software, e.g. any kind of computer program. Any other kind of implementation of the respective functions which will be described in more detail below may also be understood as a “processor”. The communication device may for example be at least partially implemented by a transceiver which may for example be at least partially implemented by a modem (e.g. an LTE modem), a baseband processor or other transceiver components or also by an application processor. The communication device may for example be a communication terminal as such and may include typical communication terminal devices such as a transceiver (including e.g. a baseband processor, one or more filters, transmit chains, receive chains, amplifiers etc.), an antenna, a subscriber identity module, an application processor, a memory etc.

According to various embodiment, the communication device is a wireless communication device. The term “wireless communication device”, as used herein, includes, for example, a device capable of wireless communication, a communication device capable of wireless communication, a communication station capable of wireless communication, a portable or non-portable device capable of wireless communication, or the like. In some aspects, a wireless device may be or may include a peripheral that is integrated with a computer, or a peripheral that is attached to a computer.

The term “antenna” as used herein may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

The following examples pertain to further exemplary implementations.

Example 1a is a communication device including a receiver configured to receive a signal from another communication device via a radio channel and a processor configured to determine a channel characteristic of the radio channel using a neural network configured a neural network in accordance with domain knowledge regarding the determination of the channel characteristic.

Example 2a is the communication device of Example 1a, wherein the neural network being configured in accordance with the domain knowledge includes at least one of: the neural network including one or more inputs selected in accordance with the domain knowledge; the neural network including one or more outputs selected in accordance with the domain knowledge; the neural network including a pre-processing layer selected in accordance with the domain knowledge; and the neural network including a post-processing layer selected in accordance with the domain knowledge and a separation of the neural network into sub-networks in accordance with the domain knowledge.

Example 3a is a method for determining a channel characteristic, including configuring a neural network in accordance with domain knowledge regarding the determination of the channel characteristic, training the neural network to determine channel characteristics from received signals and determining a channel characteristic of the radio channel using the neural network.

Example 4a is the method of Example 3a, wherein configuring the neural network in accordance with the domain knowledge includes at least one of selecting one or more inputs for the neural network, selecting one or more outputs for the neural network, selecting a pre-processing, selecting a post-processing and selecting a separation of the neural network into sub-networks.

Example 1b is a communication device including a receiver configured to receive a signal from another communication device via a radio channel and a processor configured to estimate a power delay profile of the radio channel by maximum likelihood estimation of the power delay profile from the received signal and perform receive signal processing in accordance with the estimated power delay profile.

Example 2b is the communication device of Example 1b, including estimating the power delay profile by searching for a power delay profile which maximizes the likelihood of a signal transmitted by the other communication device is equal to the received signal.

Example 3b is the communication device of Example 1b or 2b, wherein the signal is a transmission signal for a single Orthogonal Frequency Division Multiplexing symbol or for multiple Orthogonal Frequency Division Multiplexing symbols.

Example 4b is the communication device of Example 3b, including estimating the power delay profile by estimating the power for each of a plurality of consecutive time intervals.

Example 5b is the communication device of Example 4b, wherein the signal is a transmission signal for a single Orthogonal Frequency Division Multiplexing symbol and the plurality of time intervals forms a segmentation of a cyclic prefix.

Example 6b is the communication device of any one of Examples 1b to 5b, including estimating the power delay profile by constrained optimization, wherein a constraint is given by that a sum of the powers for the time intervals should be equal to one.

Example 7b is the communication device of Example 6b, including estimating the power delay profile by iterating over the power delay profile and a Lagrangian multiplier for the constraint.

Example 8b is the communication device of Example 6b or 7b, wherein further constraints are given by that the powers for the time intervals should be non-negative.

Example 9b is the communication device of any one of Examples 1b to 8b, wherein performing receive signal processing includes channel estimation.

Example 10b is a method for performing receive signal processing including receiving a signal from another communication device via a radio channel, estimating a power delay profile of the radio channel by maximum likelihood estimation of the power delay profile from the received signal and performing receive signal processing in accordance with the estimated power delay profile.

Example 11b is the method of Example 10b, including estimating the power delay profile by searching for a power delay profile which maximizes the likelihood of a signal transmitted by the other communication device is equal to the received signal.

Example 1c is a communication device including a receiver configured to receive a signal from another communication device via a radio channel and a processor configured to control a neural network to output, for an input signal, a power delay profile and a representation of a Lagrangian multiplier of a maximum likelihood estimation of the power delay profile from the input signal, supply an input to the neural network in accordance with the received signal and perform receive signal processing in accordance with a power delay profile output by the neural network in response to the input.

Example 2c is the communication device of Example 1c, wherein the signal is a transmission signal for a single Orthogonal Frequency Division Multiplexing symbol or for multiple Orthogonal Frequency Division Multiplexing symbols.

Example 3c is the communication device of Example 1c or 2c, wherein the neural network is trained to output power delay profiles in the form of a power for each of a plurality of consecutive time intervals.

Example 4c is the communication device of any one of Examples 1c to 3c, wherein the Lagrangian multiplier is a Lagrangian multiplier for a constraint given by that a sum of the powers for the time intervals should be equal to one.

Example 5c is the communication device of any one of Examples 1c to 4c, wherein the processor is configured to scale the received signal in accordance with a signal-to-noise ratio of the radio channel and wherein the input to the neural network is the scaled received signal.

Example 6c is the communication device of Example 5c, wherein the processor is configured to scale the received signal with the scare of the signal-to-noise ratio of the radio channel.

Example 7c is the communication device of any one of Examples 1c to 6c, wherein the representation of the Lagrangian multiplier is the reciprocal of the Lagrangian multiplier scaled with the signal-to-noise ratio of the radio channel.

Example 8c is the communication device of any one of Examples 1c to 7c, wherein performing receive signal processing includes channel estimation.

Example 9c is a method for performing receive signal processing including receiving a signal from another communication device via a radio channel, controlling a neural network to output, for an input signal, a power delay profile and a representation of a Lagrangian multiplier of a maximum likelihood estimation of the power delay profile from the input signal (wherein the neural network may be trained to output, for an input signal, a power delay profile and a representation of a Lagrangian multiplier of a maximum likelihood estimation of the power delay profile from the input signal), supplying an input to the neural network in accordance with the received signal; and performing receive signal processing in accordance with a power delay profile output by the neural network in response to the input.

Example 10c is the method of Example 9c, including training the neural network to output, for an input signal, a power delay profile and a representation of a Lagrangian multiplier of a maximum likelihood estimation of the power delay profile from the input signal.

Example 11c is the method of Example 10c, including training the neural network by supervised learning.

Example 12c is the method of Example 11c, including training the neural network form a loss for the power delay profile and a loss for the Lagrangian multiplier.

Example 13c is the method of Example 12c, including training the neural network form a weighted combination of the loss for the power delay profile and the loss for the Lagrangian multiplier.

Example 14c is the method of any one of Examples 11c to 13c, including training the neural network from a categorical cross entropy loss for the power delay profile and a squared error loss for the representation of the Lagrangian multiplier.

Example 15c is the method of any one of Examples 10c to 14c, including generating training data by computing received signals for randomized power delay profiles and randomized signal-to-noise ratios and training the neural network using the training data.

Example 16c is the method of Example 15c, wherein generating the training data includes generating training data elements, each including a received signal as training input and a label including a power delay profile from which the received signal was calculated and a representation of a Lagrangian multiplier of a maximum likelihood estimation of the power delay profile from the received signal.

Example 17c is the method of Example 16c, including generating the power delay profile of the label using maximum likelihood estimation of the power delay profile from the received signal of the training data element.

Example 1d is a communication device including a receiver configured to receive a signal from another communication device via a radio channel and a processor configured to control (and e.g. implement) a neural network to determine channel estimation filters from power delay profiles (wherein the neural network is for example trained to determine channel estimation filters from power delay profiles), determine a power delay profile of the radio channel from the received signal, supply the determined power delay profile to the neural network and perform signal filtering in accordance with a representation of a channel estimation filter output by the neural network in response to being supplied with the determined power delay profile.

Example 2d is the communication device of Example 1d, wherein the received signal is a demodulation reference signal.

Example 3d is the communication device of Example 1d or 2d, including determining the power delay profile by supplying an input in accordance with the received signal to a neural network trained to output, for an input signal, an estimated power delay profile and a representation of a Lagrangian multiplier of a maximum likelihood estimation of the power delay profile from the input signal.

Example 4d is the communication device of any one of Examples 1d to 3d, including determining the power delay profile by maximum likelihood estimation of the power delay profile from the received signal.

Example 5d is the communication device of any one of Examples 1d to 4d, wherein the processor is configured to determine the power delay profile by quantizing an estimated power delay profile.

Example 6d is the communication device of Example 5d, wherein determining the power delay profile by quantizing the estimated power delay profile includes setting the power delay profile constant between zero delay and a maximum delay occurring in the estimated power delay profile and zero otherwise.

Example 7d is the communication device of any one of Examples 1d to 6d, wherein the neural network is trained to determine channel estimation filters from power delay profiles and signal-to-noise ratios and wherein the processor is further configured to supply a signal-to-noise ratio of the radio channel to the neural network.

Example 8d is the communication device of any one of Examples 1d to 7d, wherein the neural network is trained to output the channel estimation filter as a set of real numbers specifying filter coefficients of the channel estimation filter.

Example 9d is the communication device of any one of Examples 1d to 8d, wherein the neural network is trained to output the channel estimation filter as a set of real numbers specifying a filter matrix of the channel estimation filter.

Example 10d is a method for filtering a signal received via wireless communication including, receiving a signal from another communication device via a radio channel, controlling a neural network to determine channel estimation filters from power delay profiles (wherein the neural network may be trained to determine channel estimation filters from power delay profiles), determining a power delay profile of the radio channel from the received signal, supplying the determined power delay profile to the neural network and performing signal filtering in accordance with a representation of a channel estimation filter output by the neural network in response to being supplied with the determined power delay profile.

Example 11d is the method of Example 10d, including training the neural network to determine channel estimation filters from power delay profiles.

Example 12d is the method of Example 11d, including training the neural network by supervised learning.

Example 1e is a communication device including a receiver configured to receive a superposition of sounding reference signals sent by a plurality of other communication devices; and a processor configured to control (and e.g. implement) a neural network to determine communication signal processing control information from receive signals (wherein the neural network may be trained to determine communication signal processing control information from receive signals), supply an input according to the received superposition of sounding reference signals to the neural network and perform radio communication signal processing in accordance with communication signal processing control information output by the neural network in response to the input.

Example 2e is the communication device of Example 1e, wherein the communication signal processing control information includes at least one of a channel frequency response, a channel frequency response averaged over multiple subcarriers, channel frequency responses for the plurality of other communication devices, compressed receive spatial compression weights for the plurality of other communication devices, transmit beamforming weights for the plurality of other communication devices, a channel quality and compressed channel frequency responses.

Example 3e is the communication device of Example 1e or 2e, wherein the neural network is a recurrent neural network.

Example 4e is the communication device of any one of Examples 1e to 3e, wherein the communication device is a base station.

Example 5e is the communication device of any one of Examples 1e to 4e, wherein the receiver is configured to receive the superposition of sounding reference signals via each of a plurality of receive antennas resulting in a superposition of sounding reference signals for each receive antenna and wherein the processor is configured to generate the input to the neural network from the superpositions of sounding reference signals received for the receive antennas.

Example 6e is the communication device of any one of Examples 1e to 5e, wherein the processor is configured to compress the superpositions of sounding reference signals received for the receive antennas to superpositions of sounding reference signals received for a set of virtual antennas with a lower number than the number of receive antennas and to generate the input to the neural network from the superpositions of sounding reference signals received for the set of virtual antennas.

Example 7e is the communication device of any one of Examples 1e to 6e, wherein the superposition of sounding reference signals includes a signal component for each of a plurality of subcarriers.

Example 8e is the communication device of any one of Examples 1e to 7e, wherein the processor is configured to divide, for each of the other communication devices, the superposition of sounding reference signals by the sounding reference signal sent by the other communication device, wherein the input includes the results of the division for each of the other communication devices.

Example 9e is a method for performing radio communication signal processing including receiving a superposition of sounding reference signals sent by a plurality of other communication devices, controlling a neural network to determine communication signal processing control information from receive signals (wherein the neural network may be trained to determine communication signal processing control information from receive signals), supplying an input according to the received superposition of sounding reference signals to the neural network and performing radio communication signal processing in accordance with communication signal processing control information output by the neural network in response to the input.

Example 10e is the method of Example 9e, including training the neural network to determine communication signal processing control information from receive signals.

Example 11e is the method of Example 10e, including training the neural network by supervised learning.

Example 12e is the method of Example 10e, including generating training data by computing received signals for randomized power delay profiles and training the neural network using the training data.

It should be noted that one or more of the features of any of the examples above may be combined with any one of the other examples and that in particular examples described in context of a device are analogously applicable for a method and vice versa.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A communication device comprising:
a receiver configured to receive a signal from another communication device via a radio channel; and
a processor configured to determine a channel characteristic of the radio channel by means of a neural network configured a neural network in accordance with domain knowledge regarding the determination of the channel characteristic.

2. The communication device of claim 1, wherein the neural network being configured in accordance with the domain knowledge comprises one or more of:
the neural network comprising one or more inputs selected in accordance with the domain knowledge;
the neural network comprising one or more outputs selected in accordance with the domain knowledge;
the neural network comprising a pre-processing layer selected in accordance with the domain knowledge; and
the neural network comprising a post-processing layer selected in accordance with the domain knowledge and a separation of the neural network into sub-networks in accordance with the domain knowledge.

3. A communication device comprising:
a receiver configured to receive a signal from another communication device via a radio channel; and
a processor configured to
control a neural network to output, for an input signal, a power delay profile and a representation of a Lagrangian multiplier of a maximum likelihood estimation of the power delay profile from the input signal;
supply an input to the neural network in accordance with the received signal; and
perform receive signal processing in accordance with a power delay profile output by the neural network in response to the input.

4. The communication device of claim 3, wherein the signal is a transmission signal for a single Orthogonal Frequency Division Multiplexing symbol or for multiple Orthogonal Frequency Division Multiplexing symbols.

5. The communication device of claim 3, wherein the neural network is trained to output power delay profiles in the form of a power for each of a plurality of consecutive time intervals.

6. The communication device of claim 3, wherein the Lagrangian multiplier is a Lagrangian multiplier for a constraint given by that a sum of the powers for the time intervals should be equal to one.

7. The communication device of claim 3, wherein the processor is configured to scale the received signal in accordance with a signal-to-noise ratio of the radio channel and wherein the input to the neural network is the scaled received signal.

8. The communication device of claim 7, wherein the processor is configured to scale the received signal with the scare of the signal-to-noise ratio of the radio channel.

9. The communication device of claim 3, wherein the representation of the Lagrangian multiplier is the reciprocal of the Lagrangian multiplier scaled with the signal-to-noise ratio of the radio channel.

10. The communication device of claim 3, wherein performing receive signal processing comprises channel estimation.

11. A communication device comprising:
a receiver configured to receive a superposition of sounding reference signals sent by a plurality of other communication devices; and
a processor configured to
control a neural network to determine communication signal processing control information from receive signals;
supply an input according to the received superposition of sounding reference signals to the neural network; and
perform radio communication signal processing in accordance with communication signal processing control information output by the neural network in response to the input.

12. The communication device of claim 11, wherein the communication signal processing control information comprises at least one of a channel frequency response, a channel frequency response averaged over multiple subcarriers, channel frequency responses for the plurality of other communication devices, compressed receive spatial compression weights for the plurality of other communication devices, transmit beamforming weights for the plurality of other communication devices, a channel quality and compressed channel frequency responses.

13. The communication device of claim 11, wherein the neural network is a recurrent neural network.

14. The communication device of claim 11, wherein the communication device is a base station.

15. The communication device of claim 11, wherein the receiver is configured to receive the superposition of sounding reference signals via each of a plurality of receive antennas resulting in a superposition of sounding reference signals for each receive antenna and wherein the processor is configured to generate the input to the neural network from the superpositions of sounding reference signals received for the receive antennas.

16. The communication device of claim 11, wherein the processor is configured to compress the superpositions of sounding reference signals received for the receive antennas to superpositions of sounding reference signals received for a set of virtual antennas with a lower number than the number of receive antennas and to generate the input to the neural network from the superpositions of sounding reference signals received for the set of virtual antennas.

17. The communication device of claim 11, wherein the superposition of sounding reference signals comprises a signal component for each of a plurality of subcarriers.

18. The communication device of claim 11, wherein the processor is configured to divide, for each of the other communication devices, the superposition of sounding reference signals by the sounding reference signal sent by the other communication device, wherein the input comprises the results of the division for each of the other communication devices.
